(19) United States
(12) Patent Application Publication
(10) Pub. No.: US 2025/0349466 A1
(43) Pub. Date: Nov. 13, 2025

(54) CERAMIC ELECTRONIC COMPONENT, METHOD FOR MANUFACTURING CERAMIC ELECTRONIC COMPONENT, AND MOUNTING BOARD

(71) Applicant: TAIYO YUDEN CO., LTD., Tokyo (JP)

(72) Inventor: Ayumi SHIROTA, Takasaki-shi (JP)

(21) Appl. No.: 19/276,517

(22) Filed: Jul. 22, 2025

Related U.S. Application Data
(63) Continuation of application No. PCT/JP2024/005109, filed on Feb. 14, 2024.

(30) Foreign Application Priority Data
Feb. 14, 2023 (JP) 2023-021005

(51) Int. Cl. H01G 4/008; H01G 4/12; H01G 4/232; H01G 4/248; H01G 4/30; H01G 13/00

(52) U.S. Cl. CPC H01G 4/008; H01G 4/1209; H01G 4/2325; H01G 4/248; H01G 4/30; H01G 13/006

(57) ABSTRACT

A ceramic electronic component, in which a dimension in a first direction is equal to or greater than 1.3 times a dimension in a second direction orthogonal to the first direction, includes a multilayer chip including dielectric layers and internal electrode layers that are alternately stacked, the internal electrode layers containing Ni as a main component, the internal electrode layers being alternately exposed to first and second end surfaces facing each other in a third direction orthogonal to the first and second directions, and external electrodes provided on the first and second end surfaces, the external electrodes each including a plating layer on a base layer, wherein each internal electrode layer contains a metal component having a melting point of 700° C. or less, and an end in the first direction of at least one internal electrode layer of the internal electrode layers is in contact with a void.

### CROSS-REFERENCE TO RELATED APPLICATION

This application is a continuation application of PCT/JP2024/005109, filed on Feb. 14, 2024, which is based upon and claims the benefit of priority of the prior Japanese Patent Application No. 2023-021005, filed on Feb. 14, 2023, the entire contents of which are incorporated herein by reference.

### FIELD

A certain aspect of the present disclosure relates to a ceramic electronic component, a method for manufacturing a ceramic electronic component, and a mounting board.

### BACKGROUND

In recent years, electronic devices such as portable information terminals have been reduced in size, and the mounting area of ceramic electronic components on a circuit board has been limited. On the other hand, the increasing sophistication of devices has led to a demand for even higher capacitance in multilayer ceramic capacitors. Furthermore, in the field of electric vehicles and the like, there is a demand for improvement in high-temperature load life and moisture resistance reliability.

### SUMMARY

In an aspect of the present disclosure, there is provided a ceramic electronic component in which a dimension in a first direction is equal to or greater than 1.3 times a dimension in a second direction orthogonal to the first direction, the ceramic electronic component including: a multilayer chip having a substantially rectangular parallelepiped shape, the multilayer chip including a plurality of dielectric layers and a plurality of internal electrode layers that are alternately stacked, the internal electrode layers containing Ni as a main component, the internal electrode layers being alternately exposed to a first end surface and a second end surface, which face each other in a third direction orthogonal to the first direction and the second direction, of the multilayer chip; and a pair of external electrodes provided on the first end surface and the second end surface, respectively, the pair of external electrodes each including a plating layer on a base layer; wherein each of the internal electrode layers contains a metal component having a melting point of 700° C. or less, and wherein an end in the first direction of at least one internal electrode layer of the internal electrode layers is in contact with a void.

In another aspect of the present disclosure, there is provided a method of manufacturing a ceramic electronic component in which a dimension in a first direction is equal to or greater than 1.3 times a dimension in a second direction orthogonal to the first direction, the method including: obtaining a first multilayer body in which a plurality of multilayer units are stacked in the second direction, each of the multilayer units including a dielectric green sheet and an internal electrode pattern formed on the dielectric green sheet, the internal electrode pattern including Ni as a main component and a metal component having a melting point of 700° C. or less added thereto; obtaining a second multilayer body in which side margin sheets are stacked on a top and bottom of the first multilayer body in a stacking direction of the multilayer units, respectively; obtaining a third multilayer body to which cover layers are attached, the cover layers covering a first surface and a second surface of the second multilayer body, respectively, the first surface and the second surface having the internal electrode patterns exposed therefrom; and forming base layers containing a metal as a main component on a first end surface and a second end surface of the third multilayer body, respectively when the third multilayer body is fired or after the third multilayer body is fired, the first end surface and the second end surface facing each other.

In another aspect of the present disclosure, there is provided a mounting board including: a mounting surface; and a pair of connection electrodes provided on the mounting surface, wherein the pair of external electrodes of the above ceramic electronic component are connected to the pair of connection electrodes via solder so that one of two main surfaces facing each other in the first direction of the ceramic electronic component faces the mounting surface.

### BRIEF DESCRIPTION OF THE DRAWINGS

FIG. 1A is a partial cross-sectional perspective view of a multilayer ceramic capacitor according to a first embodiment, and FIG. 1B is a side view of the multilayer ceramic capacitor according to the first embodiment;

FIG. 2A is a cross-sectional view taken along line A-A in FIG. 1B, and FIG. 2B is a cross-sectional view taken along line B-B in FIG. 1B;

FIG. 3 is an enlarged cross-sectional view of the vicinity of an external electrode;

FIG. 4A is a partial cross-sectional perspective view of a multilayer ceramic capacitor according to a comparative example, and FIG. 4B is a cross-sectional view of the multilayer ceramic capacitor according to the comparative example;

FIG. 5 is a side view illustrating mounting of the multilayer ceramic capacitor on a mounting board;

FIG. 6 is a flowchart illustrating a method for manufacturing a multilayer ceramic capacitor;

FIG. 7 illustrates an overview of a method for manufacturing the multilayer ceramic capacitor according to the first embodiment;

FIG. 8 is a partial cross-sectional perspective view of a multilayer ceramic capacitor according to a second embodiment;

FIG. 9A and FIG. 9B are cross-sectional views of a multilayer ceramic capacitor according to a second embodiment;

FIG. 10 illustrates an overview of a method for manufacturing the multilayer ceramic capacitor according to the second embodiment;

FIG. 11 illustrates cracks;

FIG. 12 is a partial cross-sectional perspective view of a multilayer ceramic capacitor according to a third embodiment;

FIG. 13A and FIG. 13B are cross-sectional views of the multilayer ceramic capacitor according to the third embodiment;

FIG. 14 illustrates a first section and a second section of an internal electrode layer;

FIG. 15 illustrates an overview of a method for manufacturing the multilayer ceramic capacitor according to the third embodiment;

FIG. 16 is a partial cross-sectional perspective view of a multilayer ceramic capacitor according to a fourth embodiment;

FIG. 17A and FIG. 17B are cross-sectional views of the multilayer ceramic capacitor according to the fourth embodiment;

FIG. 18 illustrates an overview of a method for manufacturing the multilayer ceramic capacitor according to the fourth embodiment;

FIG. 19A and FIG. 19B are partial cross-sectional perspective views of a multilayer ceramic capacitor according to a fifth embodiment;

FIG. 20A and FIG. 20B are cross-sectional views of the multilayer ceramic capacitor according to the fifth embodiment; and

FIG. 21 illustrates an overview of a method for manufacturing the multilayer ceramic capacitor according to the fifth embodiment.

### DETAILED DESCRIPTION

To improve the high-temperature load life, a multilayer ceramic capacitor has been proposed in which tin (Sn) is added to an internal electrode layer containing nickel (Ni) as a main component as disclosed in Japanese Patent Application Publication No. 2018-117051 (Patent Document 1). However, when a low-melting-point metal such as Sn is added to the internal electrode layer, a difference between the shrinkage behavior of the dielectric layer and the shrinkage behavior of the internal electrode layer during firing becomes larger, and thus a voids are formed between the ends in the width direction of the internal electrode layer and the side margin portions protecting the ends in the width direction of the internal electrode layer, and the moisture resistance is lowered as disclosed in Japanese Patent Application Publication No. 2021-034648 (Patent Document 2).

Hereinafter, embodiments will be described with reference to the drawings.

### First Embodiment

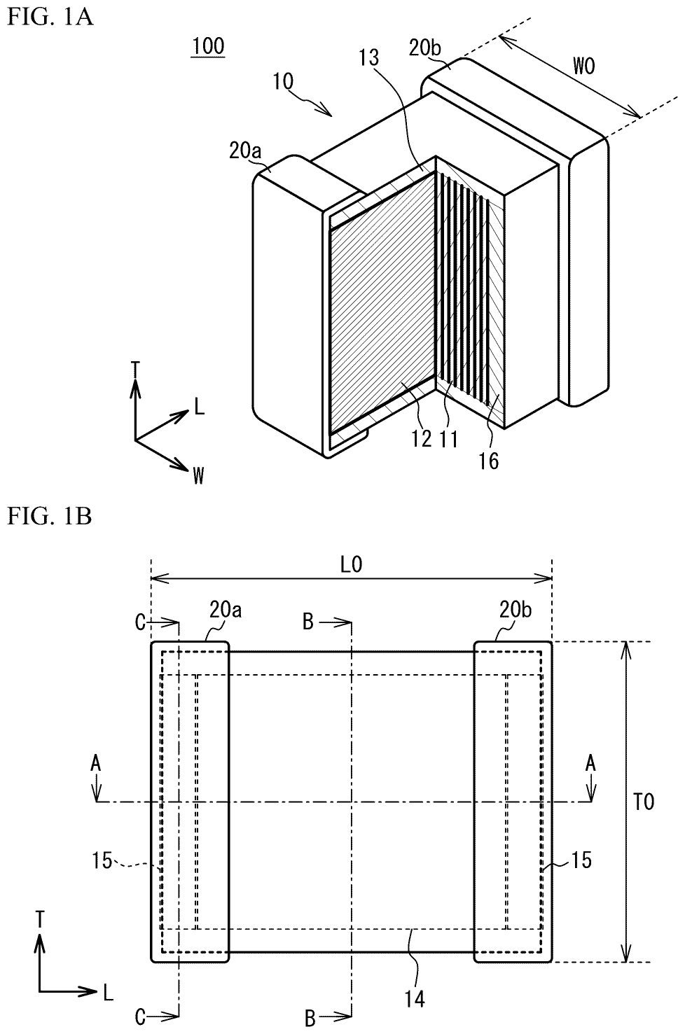

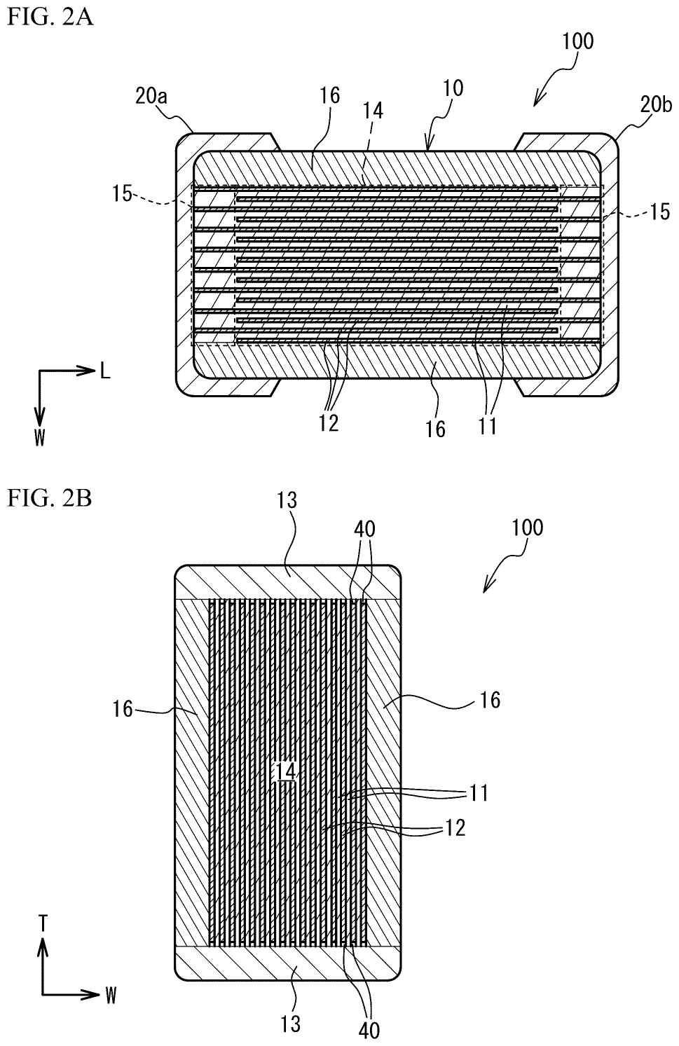

FIG. 1A is a partial cross-sectional perspective view of a multilayer ceramic capacitor 100 according to a first embodiment, and FIG. 1B is a side view of the multilayer ceramic capacitor 100. FIG. 2A is a cross-sectional view taken along line A-A in FIG. 1B, and FIG. 2B is a cross-sectional view taken along line B-B in FIG. 1B.

As illustrated in FIG. 1A, the multilayer ceramic capacitor 100 includes a multilayer chip 10 having a substantially rectangular parallelepiped shape, and external electrodes 20a and 20b provided on two end surfaces of the multilayer chip 10 facing each other, respectively. Among the four surfaces of the multilayer chip 10 other than the two end surfaces, two surfaces facing each other in the stacking direction are referred to as side surfaces, and the other two surfaces are referred to as main surfaces. The external electrodes 20a and 20b extend on two main surfaces and two side surfaces of the multilayer chip 10. However, the external electrodes 20a and 20b are separated from each other.

In FIG. 1A to FIG. 2B, the L direction is the length direction of the multilayer chip 10, the direction in which the two end surfaces of the multilayer chip 10 face each other, and the direction in which the external electrode 20a and the external electrode 20b face each other. The W direction is a stacking direction of dielectric layers 11 and internal electrode layers 12, and is a direction in which two side surfaces of the multilayer chip 10 face each other. The T direction is a height direction of the multilayer chip 10, and is a direction in which two main surfaces of the multilayer chip 10 face each other. The L direction, the W direction, and the T direction are orthogonal to each other.

The multilayer chip 10 has a structure in which the dielectric layers 11 containing a ceramic material functioning as a dielectric and the internal electrode layers 12 containing a metal as a main component are alternately stacked. In other words, the multilayer chip 10 includes a plurality of the internal electrode layers 12 facing each other and the dielectric layers 11 each sandwiched between the internal electrode layers 12. The edges of the internal electrode layers 12 in the extending direction of the internal electrode layers 12 are alternately exposed to a first end surface on which the external electrode 20a of the multilayer chip 10 is provided and a second end surface on which the external electrode 20b is provided. The internal electrode layers 12 connected to the external electrode 20a are not connected to the external electrode 20b. The internal electrode layers 12 connected to the external electrode 20b are not connected to the external electrode 20a. Therefore, the internal electrode layers 12 are alternately electrically connected to the external electrode 20a and the external electrodes 20b. In the multilayer body of the dielectric layers 11 and the internal electrode layers 12, the internal electrode layer 12 is disposed at the uppermost layer in the stacking direction, the internal electrode layer 12 is also disposed at the lowermost layer in the stacking direction, the two side surfaces of the multilayer body are covered with side margins 16, respectively, and the two main surfaces of the multilayer body are covered with cover layers 13, respectively. The side margin 16 is mainly composed of a ceramic material. For example, the main component of the side margin 16 is the same as the main component of the dielectric layer 11. The cover layer 13 is mainly composed of a ceramic material. For example, the main component of the cover layer 13 is the same as the main component of the dielectric layer 11.

The dielectric layer 11 includes, for example, a ceramic material having a perovskite structure represented by a general formula ABO₃ as a main phase. The perovskite structure includes ABO_{3-α} that has an off-stoichiometric composition. For example, the ceramic material may be selected from at least one the following substances: BaTiO₃ (barium titanate), CaZrO₃ (calcium zirconate), CaTiO₃ (calcium titanate), SrTiO₃ (strontium titanate), and MgTiO₃ (magnesium titanate), Ba_{1-x-y}CaₓSr_{y}Ti_{1-Z}Zr_{Z}O₃ (0≤x≤1, 0≤y≤1, 0≤z≤1) forming a perovskite structure. Ba_{1-x-y}CaₓSr_{y}Ti_{1-Z}Zr_{Z}O₃ is barium strontium titanate, barium calcium titanate, barium zirconate, barium zirconate titanate, calcium zirconate titanate, barium calcium zirconate titanate, or the like.

An additive may be added to the dielectric layer 11. Examples of the additive to the dielectric layer 11 include oxides of magnesium (Mg), manganese (Mn), molybdenum (Mo), vanadium (V), chromium (Cr), and rare earth elements (yttrium (Y), samarium (Sm), europium (Eu), gadolinium (Gd), terbium (Tb), dysprosium (Dy), holmium (Ho), erbium (Er), thulium (Tm), and ytterbium (Yb)), oxides containing cobalt (Co), nickel (Ni), lithium (Li), boron (B), sodium (Na), potassium (K), or silicon (Si), and glass containing Co, Ni, Li, B, Na, K, or Si.

The thickness of each dielectric layer 11 in the W direction is, for example, 0.1 μm or greater and 2 μm or less. The thickness of each dielectric layer 11 in the W direction can be measured by exposing the cross section of the multilayer ceramic capacitor 100 illustrated in FIG. 2A by mechanical polishing, and then obtaining an average value of the thicknesses at 10 locations from an image taken by a microscope such as a scanning transmission electron microscope.

The internal electrode layer 12 contains Ni as a main component. In the present embodiment, a metal component having a melting point of 700° C. or less (hereinafter, referred to as a low-melting-point metal) is added to the internal electrode layer 12 in order to increase the electrical barrier at the interface between the dielectric layer 11 and the internal electrode layer 12 and improve the high-temperature load life. The low-melting-point metal is not particularly limited as long as the melting point is lower than 700° C. and examples thereof include gallium (Ga), indium (In), tin (Sn), bismuth (Bi), lead (Pb), and zinc (Zn). The low-melting-point metal may be alloyed with Ni, which is the main component of the internal electrode layer 12, or may be disposed as a single metal. For example, the low-melting-point metal may be disposed so as to be uniformly dispersed in the internal electrode layer 12, or may be segregated at the interface between the internal electrode layer 12 and the dielectric layer 11.

The concentration of the low-melting point metal in the internal electrode layer 12 is, for example, 1 at %. Here, the concentration of the low-melting-point metal is the amount (at %) of the low-melting-point metal in the whole of one internal electrode layer 12 sandwiched between two adjacent dielectric layers 11, when the amount of Ni in the internal electrode layer 12 is defined as 100 at %. When a plurality of types of low-melting-point metals are contained, the concentration of the low-melting-point metal is the total amount of the plurality of types of low-melting-point metals.

To increase the electrical barrier at the interface between the dielectric layer 11 and the internal electrode layer 12 and improve the high-temperature load life, the concentration of the low-melting-point metal in the internal electrode layer 12 is preferably 0.3 at % or greater, and more preferably 0.5 at % or greater. On the other hand, to suppress excessive shrinkage of the internal electrode layer 12, the concentration of the low-melting-point metal in the internal electrode layer 12 is preferably 5 at % or less, and more preferably 3 at % or less.

The thickness of each internal electrode layer 12 in the W direction is, for example, 0.1 μm or greater and 2 μm or less. The thickness of each internal electrode layer 12 in the W direction can be measured by exposing the cross section of the multilayer ceramic capacitor 100 illustrated in FIG. 2A by mechanical polishing, and then obtaining an average value of the thicknesses at 10 locations from an image taken by a microscope such as a scanning transmission electron microscope.

As illustrated in FIG. 2A, a section where the internal electrode layers 12 connected to the external electrode 20a and the internal electrode layers 12 connected to the external electrode 20b face each other is a section where electrostatic capacitance is generated in the multilayer ceramic capacitor 100. Therefore, the section where the electrostatic capacitance is generated is referred to as a capacitance section 14. That is, the capacitance section 14 is a section where adjacent internal electrode layers connected to different external electrodes face each other.

A section where the internal electrode layers 12 connected to the external electrode 20a face each other without the internal electrode layers 12 connected to the external electrode 20b interposed therebetween is referred to as an end margin 15. The section where the internal electrode layers 12 connected to the external electrode 20b face each other without the internal electrode layers 12 connected to the external electrode 20a interposed therebetween is also the end margin 15. That is, the end margin is a section where the internal electrode layers connected to the same external electrode face each other without the internal electrode layers connected to another external electrode interposed therebetween. The end margin 15 is a section where no capacitance is generated. The end margin 15 may have the same composition as the dielectric layer 11 of the capacitance section 14, or may have a different composition.

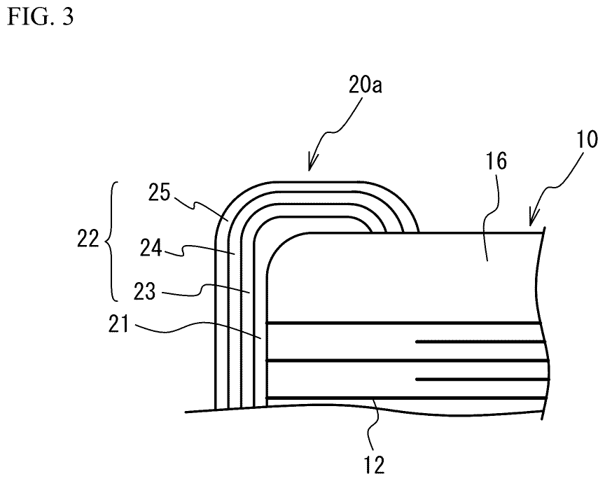

FIG. 3 is an enlarged cross-sectional view of the vicinity of the external electrode 20a. In FIG. 3, hatching is omitted. As illustrated in FIG. 3, the external electrode 20a has a structure in which a plating layer 22 is provided on a base layer 21 that is a contact layer in contact with the first end surface of the multilayer chip 10. The base layer 21 contains Ni, Cu, or the like as a main component. The base layer 21 may contain ceramic particles such as BaTiO₃ as a co-material, and may contain a glass component. The plating layer 22 is mainly composed of a metal such as Cu, Ni, aluminum (Al), zinc (Zn), or Sn, or an alloy of two or more of these metals. The plating layer 22 may be a plating layer of a single metal component, or may be a plurality of plating layers of different metal components. For example, the plating layer 22 has a structure in which a first plating layer 23, a second plating layer 24, and a third plating layer 25 are formed in this order from the base layer 21 side. The first plating layer 23 is, for example, a Cu plating layer. The second plating layer 24 is, for example, a Ni plating layer. The third plating layer 25 is, for example, a Sn plating layer. Although FIG. 3 illustrates the external electrode 20a, the external electrode 20b also has the same multilayer structure.

Here, a problem that occurs when a low-melting-point metal is added to the internal electrode layer containing Ni as a main component in a multilayer ceramic capacitor according to a comparative example will be described.

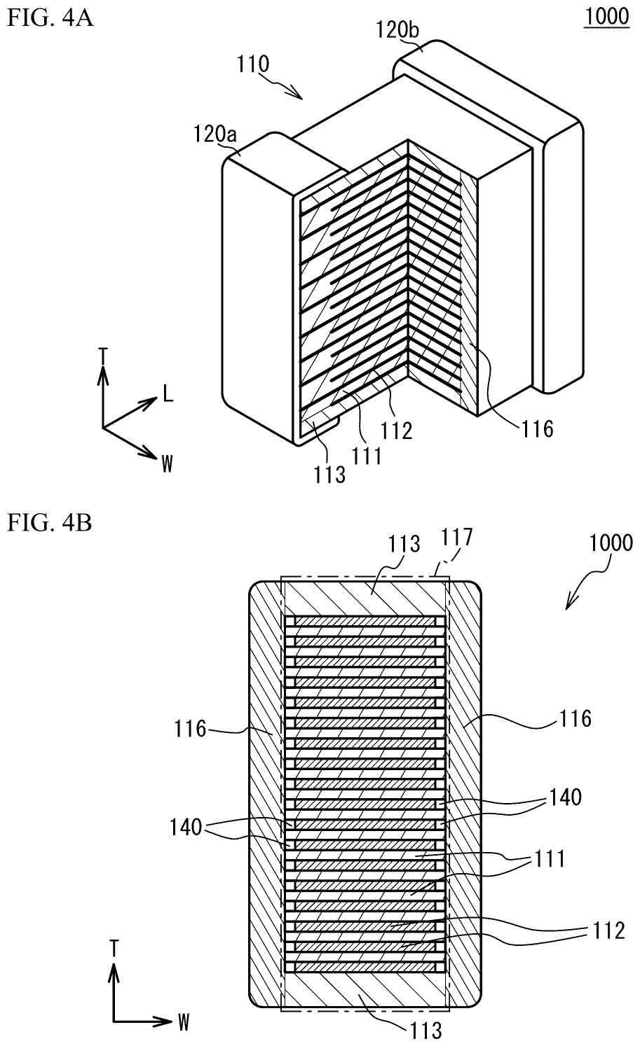

FIG. 4A is a partial cross-sectional perspective view of a multilayer ceramic capacitor 1000 according to the comparative example, and FIG. 4B is a cross-sectional view of the multilayer ceramic capacitor 1000 according to the comparative example. FIG. 4B illustrates a cross section at the same position as that in FIG. 2B.

In the multilayer ceramic capacitor 1000, an internal electrode layer 112 is mainly composed of Ni and contain a low-melting-point metal. The concentration of the low-melting-point metal in the internal electrode layer 112 is, for example, 1 at %.

Dielectric layers 111, cover layers 113, and side margins 116 include a ceramic material having a perovskite structure represented by a general formula ABO₃ as a main phase, and have substantially the same composition. The main component of the base layer of an external electrode 120a is, for example, Cu.

A multilayer chip 110 of the multilayer ceramic capacitor 1000 has a structure in which a plurality of the dielectric layers 111 and a plurality of the internal electrode layers 112 are alternately stacked in the T direction. The cover layers 113 are provided on the top and the bottom of the multilayer structure of the dielectric layers 111 and the internal electrode layers 112, respectively. The side margins 116 cover both ends in the W direction of a multilayer body 117 including the dielectric layers 111, the internal electrode layers 112, and the cover layers 113.

In this case, when the internal electrode layers 112 contain a low-melting-point metal, the difference between the shrinkage behavior of the dielectric layers 111 and the shrinkage behavior of the internal electrode layers 112 becomes larger during firing. As a result, as illustrated in FIG. 4B, voids 140 are formed between the ends in the W direction of the internal electrode layer 112 and the side margins 116, respectively, and the moisture resistance is reduced. In the present embodiment, the void 140 means a void having a dimension in the W direction or the T direction equal to or larger than the average thickness of the internal electrode layer 112.

Therefore, the multilayer ceramic capacitor 100 according to the present embodiment has a configuration that enables an increase in capacitance and an improvement in moisture resistance when a low-melting-point metal is added to the internal electrode layers 12.

In order to achieve a multilayer ceramic capacitor having a large capacitance, it is important to increase the total facing area of the internal electrode layers. In order to achieve a large capacitance without increasing the mounting area, it is conceivable to increase the number of stacked internal electrode layers. For example, as illustrated in FIG. 4A, it is conceivable to increase the number of stacked internal electrode layers 12 while suppressing an increase in the area of each internal electrode layer 12. This configuration is expected to increase the total facing area of the internal electrode layers 12, thus achieving a large capacitance. However, when the number of stacked layers is large, the ratio of the voids formed between the internal electrode layers and the side margins is increased, and the moisture resistance is reduced.

Therefore, the multilayer ceramic capacitor 100 according to the present embodiment has a configuration in which the area of each internal electrode layer is increased and the number of stacked layers is reduced. In particular, as illustrated in FIG. 1A and FIG. 1B, when the height of the multilayer ceramic capacitor 100 in the T direction is defined as a height TO, the width in the W direction is defined as a width W0, and the length in the L direction is defined as a length L0, the multilayer ceramic capacitor 100 has a relationship of T0≥ W0×1.3. With such a configuration, the width of the internal electrode layer 12 can be increased, while the number of stacked internal electrode layers 12 can be reduced, and thus the ratio of voids 40 (see FIG. 2B) formed between the internal electrode layers 12 and the cover layers 13 can be made lower than the ratio of the voids 140 (see FIG. 4B) formed between the internal electrode layers 112 and the side margins 116 in the comparative example. This can improve the moisture resistance more than the comparative example. The ratio of the voids is a ratio of the sum of the areas of the voids to the total area of the multilayer chip 10 in a cross section of the multilayer chip 10 orthogonal to the L direction at the center of the multilayer chip 10 in the L direction. The ratio of the voids can be obtained by exposing the cross section of FIG. 2B by mechanical polishing, and then measuring the total area of the multilayer chip 10 and the area of each void from an image taken by a microscope such as a scanning transmission electron microscope. The height TO, the width W0, and the length L0 are the maximum dimensions in the T direction, the W direction, and the L direction, respectively.

In addition, in the present embodiment, since the internal electrode layers 12 and the dielectric layers 11 are alternately stacked in the W direction, noise sound generated when a voltage is applied to the external electrodes 20a and 20b of the multilayer ceramic capacitor 100 mounted on a mounting board is reduced or prevented. This point will be described in detail.

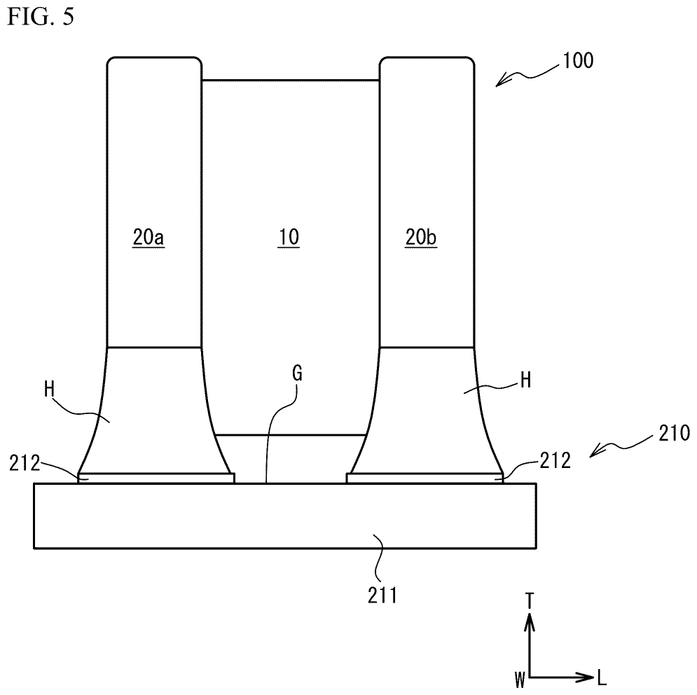

FIG. 5 is a side view illustrating mounting of the multilayer ceramic capacitor on a mounting board. A mounting board 210 includes a base material 211 that extends along a plane in the L direction and the W direction and having a mounting surface G perpendicular to the T direction, and a pair of connection electrodes 212 provided on the mounting surface G.

When the multilayer ceramic capacitor 100 is mounted on the mounting board 210, one of the two main surfaces of the multilayer ceramic capacitor 100 that face each other in the T direction is caused to face the mounting surface G of the mounting board 210.

The external electrodes 20a and 20b of the multilayer ceramic capacitor 100 are connected to the pair of connection electrodes 212 of the mounting board 210 via solder H, respectively. Thus, the multilayer ceramic capacitor 100 is fixed to and electrically connected to the mounting board 210.

It is known that, in the multilayer ceramic capacitor 100, when a voltage is applied to the external electrodes 20a and 20b via the connection electrodes 212 of the mounting board 210, an electrostriction is generated in the multilayer chip 10 by the piezoelectric effect. The electrostriction generated in the multilayer chip 10 causes relatively large deformation in the stacking direction of the internal electrode layers 12.

When the electrostriction is repeatedly generated in the multilayer ceramic capacitor 100 to which the AC voltage is applied, vibration in the thickness direction may be generated in the base material 211 of the mounting board 210. When the vibration generated in the base material 211 becomes large, a phenomenon called “acoustic noise” in which noise sound is generated from the base material 211 may occur.

In the multilayer ceramic capacitor 100 according to the present embodiment, the stacking direction of the internal electrode layers 12 is the in-plane direction of the base material 211, and thus, vibration in the thickness direction is unlikely to occur in the base material 211 due to the electrostriction of the multilayer chip 10. In addition, in the multilayer ceramic capacitor 100, the number of the stacked internal electrode layers 12 is small, and the amount of deformation due to electrostriction is suppressed to be small, and thus, even when vibration occurs in the base material 211, the vibration is unlikely to be large enough to cause noise sound.

As described above, according to the present embodiment, noise sound generated when a voltage is applied to the external electrodes 20a and 20b of the multilayer ceramic capacitor 100 mounted on the mounting board 210 is reduced or prevented.

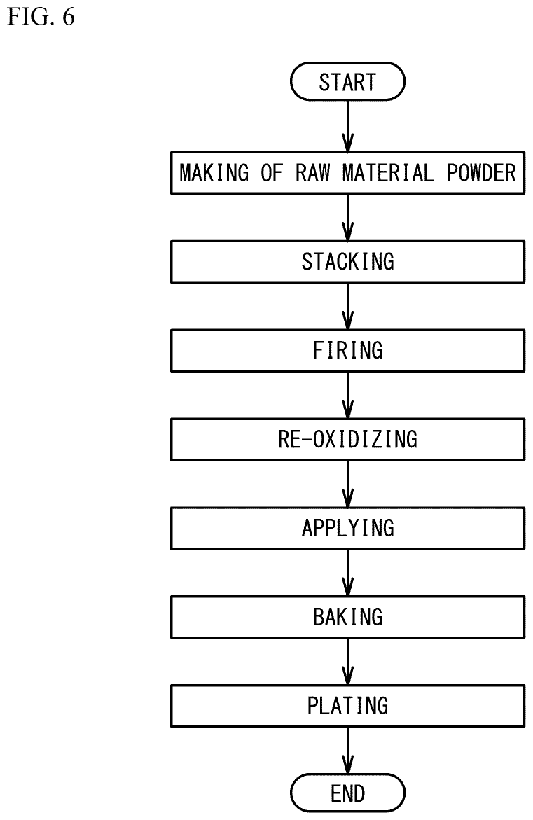

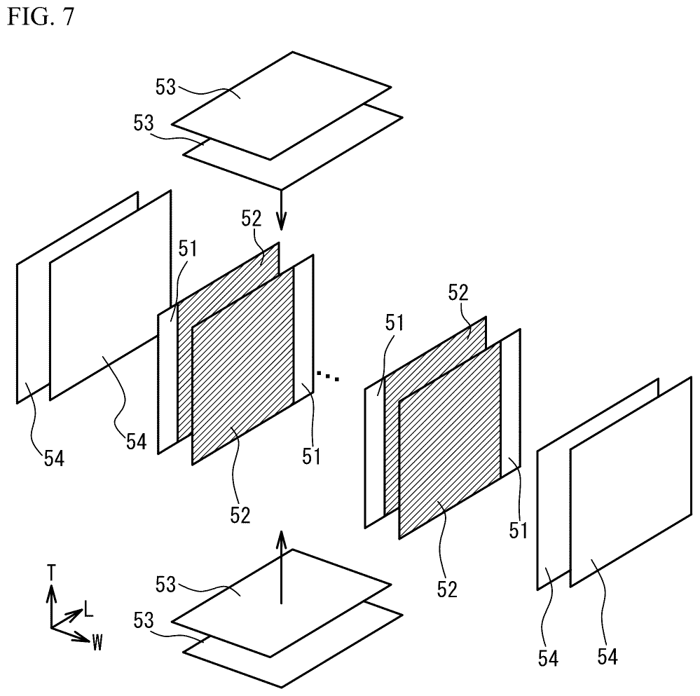

Next, a method for manufacturing the multilayer ceramic capacitor 100 according to the first embodiment will be described. FIG. 6 is a flowchart illustrating a method for manufacturing the multilayer ceramic capacitor 100. FIG. 7 illustrates an overview of the method for manufacturing the multilayer ceramic capacitor 100.

### Making of Raw Material Powder

First, a dielectric material for forming the dielectric layer 11 is prepared. The A-site element and the B-site element contained in the dielectric layer 11 are usually contained in the dielectric layer 11 in the form of a sintered body of ABO₃ particles. For example, BaTiO₃ is a tetragonal compound having a perovskite structure and exhibits a high dielectric constant. In general, BaTiO₃ can be obtained by reacting a titanium raw material such as titanium dioxide with a barium raw material such as barium carbonate to synthesize barium titanate. As a method of synthesizing the main component ceramic of the dielectric layer 11, various methods have been known, and for example, a solid phase method, a sol-gel method, a hydrothermal method, and the like are known. In the present embodiment, any of these can be adopted.

A predetermined additive compound is added to the resulting ceramic powder according to the purpose. Examples of the additive compound include oxides of Mg, Mn, Mo, V, Cr, and rare earth elements (Y, Sm, Eu, Gd, Tb, Dy, Ho, Er, Tm, and Yb), oxides containing Co, Ni, Li, B, Na, K, or Si, or glasses containing Co, Ni, Li, B, Na, K, or Si. Among these, SiO₂ mainly functions as a sintering aid.

For example, a compound containing an additive compound is wet-mixed with a ceramic raw material powder, and the mixture is dried and pulverized to prepare a ceramic material. For example, the ceramic material obtained as described above may be subjected to a pulverization treatment to adjust the particle size, or may be subjected to a pulverization treatment in combination with a classification treatment to adjust the particle size, as necessary. The dielectric material is obtained by the above steps. When Mg is added to the dielectric material, the Mg concentration is preferably 0.5 at % or less, more preferably 0.25 at % or less, to reduce or prevent a decrease in dielectric constant. The Mg concentration in the dielectric material is the amount (at %) of Mg when the amount of the B-site element in the dielectric material is defined as 100 at %.

Then, a margin material for forming the side margin 16 is prepared. The margin material includes the main component ceramic of the side margin 16. As the main component ceramic, for example, BaTiO₃ powder is prepared. The BaTiO₃ powder can be prepared by the same procedure as that for the dielectric material. A predetermined additive compound is added to the resulting BaTiO₃ powder according to the purpose. Examples of the additive compound include oxides of Zr, Ca, Sr, Mg, Mn, V, Cr, and rare earth elements, and oxides of Co, Ni, Li, B, Na, K, and Si, and glasses.

Then, a cover material for forming the cover layer 13 is prepared. The cover material includes the main component ceramic of the cover layer 13. As the main component ceramic, for example, BaTiO₃ powder is prepared. The BaTiO₃ powder can be prepared by the same procedure as that for the dielectric material. A predetermined additive compound is added to the resulting BaTiO₃ powder according to the purpose. Examples of the additive compound include oxides of Zr, Ca, Sr, Mg, Mn, V, Cr, and rare earth elements, and oxides of Co, Ni, Li, B, Na, K, and Si, and glasses.

### Stacking

Then, a binder such as polyvinyl butyral (PVB) resin, an organic solvent such as ethanol or toluene, and a plasticizer are added to the dielectric material obtained in the making of raw material powder, and wet-mixed. The resulting slurry is applied onto a base material by, for example, a die coater method or a doctor blade method, and dried to obtain a dielectric green sheet 51. The base material is, for example, a polyethylene terephthalate (PET) film.

Then, as illustrated in FIG. 7, an internal electrode pattern 52 is formed on the dielectric green sheet 51. The dielectric green sheet 51 on which the internal electrode pattern 52 is formed is defined as a multilayer unit. The width in the T direction of the internal electrode pattern 52 is adjusted to be the same as the width in the T direction of the dielectric green sheet 51. In FIG. 7, the internal electrode patterns 52 are indicated by hatching.

For the internal electrode pattern 52, used is a metal paste containing Ni, which is the main component metal of the internal electrode layer 12, and a low-melting point metal added thereto. The low-melting-point metal is not particularly limited as long as the melting point is 700° C. or less, and examples thereof include Ga, In, Sn, Bi, Pb, and Zn.

The concentration of the low-melting-point metal in the metal paste is, for example, 1 at %. The concentration of the low-melting-point metal in the metal paste is the amount (at %) of the low-melting-point metal when the amount of Ni in the metal paste is defined as 100 at %. When a plurality of types of low-melting-point metals are contained, the concentration of the low-melting-point metal is the total amount of the plurality of types of low-melting-point metals.

To increase the electrical barrier at the interface between the dielectric layer 11 and the internal electrode layer 12, the concentration of the low-melting-point metal in the metal paste is preferably 0.3 at % or greater, and more preferably 0.5 at % or greater. On the other hand, to reduce or prevent excessive shrinkage of the internal electrode layers 12, the concentration of the low-melting-point metal in the metal paste is preferably 5 at % or less, and more preferably 3 at % or less. The method of forming the film may be printing, sputtering, vapor deposition, or the like.

Then, the dielectric green sheet 51 is peeled off from the base material, and the multilayer units are stacked as illustrated in FIG. 7.

As illustrated in FIG. 7, a predetermined number (for example, 2 to 10) of side margin sheets 54 are stacked on the surface in the stacking direction of the multilayer body obtained by stacking the multilayer units, and are thermally compressed. The side margin sheet 54 can be formed by the same method as that of the dielectric green sheet 51.

Then, a plurality of cover sheets 53 are attached to each of two main surfaces of a multilayer body obtained by stacking the side margin sheets 54 and the multilayer units. The cover sheet 53 can be formed by the same method as that of the dielectric green sheet 51.

### Firing

Thereafter, the resultant is fired in a reductive atmosphere with an oxygen partial pressure of 10-5 atm to 10-8 atm at 1100° C. to 1300° C. for 10 minutes to 2 hours.

### Re-Oxidizing

Thereafter, reoxidation treatment may be performed at 600° C. to 1000° C. in an N₂ gas atmosphere.

### Applying

Then, a metal paste containing a metal such as Cu or Ni as a main component, which is to be the base layer 21, is applied to the first side surface of the multilayer body by a dipping method or the like. The metal paste contains a glass component such as glass frit.

### Baking

Then, the metal paste is baked at a temperature of about 700° C. to 900° C. to form the base layer 21.

### Plating

Thereafter, a metal coating of copper, nickel, tin, or the like may be formed on the base layer 21 by plating. For example, the first plating layer 23, the second plating layer 24, and the third plating layer 25 are formed in this order on the base layer 21. Thus, the multilayer ceramic capacitor 100 is completed.

According to the manufacturing method of the present embodiment, the internal electrode layers 12 and the dielectric layers 11 are alternately stacked in the W direction. Therefore, in the present embodiment, the ratio of the voids formed between the internal electrode layers 12 and the cover layers 13 is lower than the ratio of the voids formed between the internal electrode layers 112 and the side margins 116 when the internal electrode layers 112 and the dielectric layers 111 are alternately stacked in the T direction as illustrated in FIG. 4A. This improves the moisture resistance as compared with the case where the internal electrode layers 112 and the dielectric layers 111 are alternately stacked in the T direction.

In the above-described manufacturing method, the base layer 21 is baked after the multilayer chip 10 is fired, but the base layer 21 may be fired at the same time as when the multilayer chip 10 is fired. Similarly, in the following embodiments, the base layer 21 may be fired at the same time as when the multilayer chip 10 is fired.

### Second Embodiment

In the first embodiment, the Mg concentrations of the dielectric layers 11, the cover layers 13, and the side margins 16 are the same, but in a second embodiment, the Mg concentration of a side margin 16a is adjusted to be higher than the Mg concentration of the dielectric layers 11 and the Mg concentration of the cover layers 13.

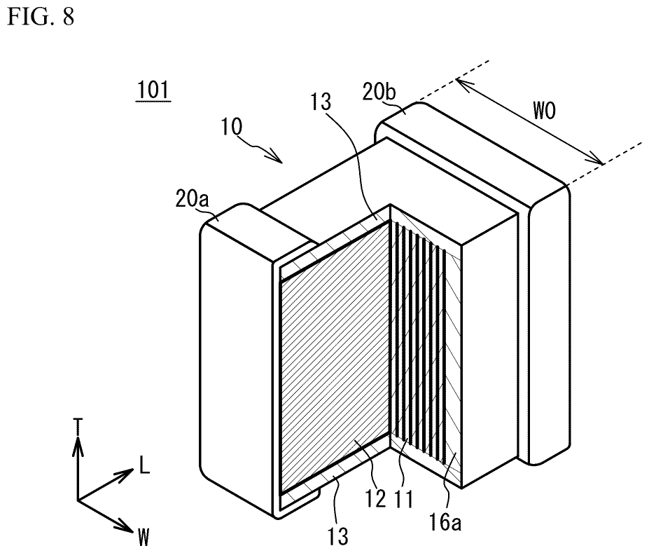

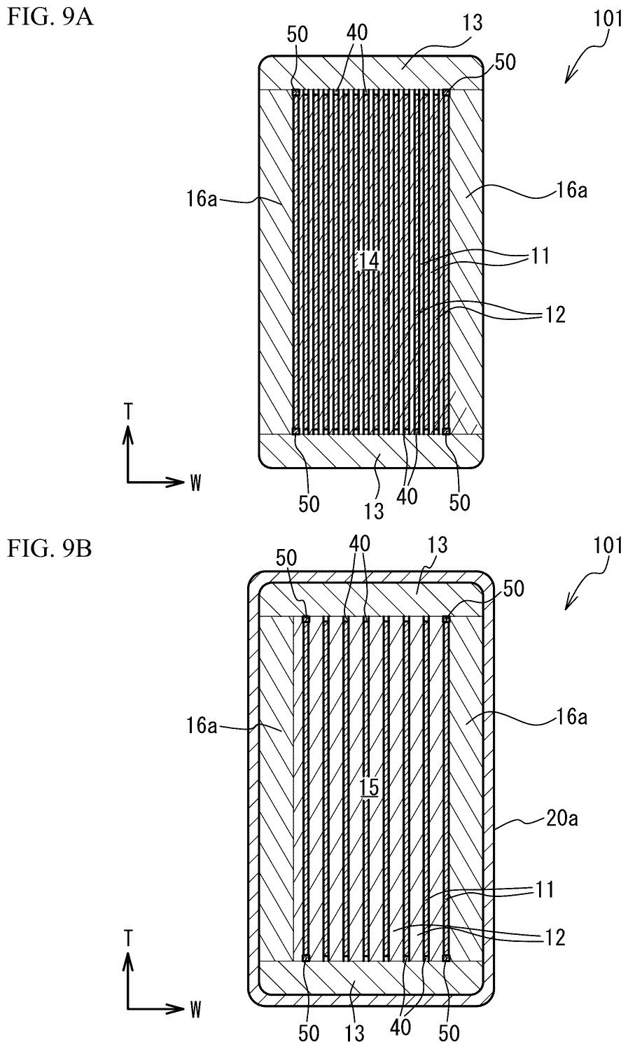

FIG. 8 is a partial cross-sectional perspective view of a multilayer ceramic capacitor 101 according to the second embodiment. FIG. 9A and FIG. 9B are cross-sectional views of the multilayer ceramic capacitor 101, where FIG. 9A illustrates a cross section at the same position as in FIG. 2B, and FIG. 9B illustrates a cross section at the end margin 15, which corresponds to the cross section taken along line C-C in FIG. 1B.

In the multilayer ceramic capacitor 101, Mg is added to the side margin 16a, and the Mg concentration of the side margin 16a is higher than the Mg concentration of the dielectric layer 11. Therefore, as illustrated in FIG. 9A, the outermost internal electrode layer 12 in the stacking direction (W direction) has oxides 50 containing Ni and Mg at both ends in the T direction, and thus the voids 40 between both ends in the T direction of the outermost internal electrode layers 12 and the cover layers 13 are suppressed. In addition, the oxide 50 can inhibit the ingress of moisture, thus reducing the degradation in moisture resistance in the portion of the multilayer chip 10 that is not covered by the external electrode 20a or 20b. The void is a void having a dimension in the W direction or the T direction equal to or greater than the average thickness of the internal electrode layer 12 in the W direction.

As illustrated in FIG. 9B, in the end margin 15, the outermost internal electrode layer 12 of the internal electrode layers 12 connected to the external electrode 20a have the oxides 50 containing Ni and Mg at both ends in the T direction. Although the lowermost internal electrode layer 12 of the internal electrode layers 12 connected to the external electrode 20a is not in contact with the side margin 16a having a higher Mg concentration, the distance between the lowermost internal electrode layer 12 and the side margin 16a is short, and the internal electrode layers 12 connected to the external electrode 20b are not present, so that the oxides 50 containing Ni and Mg are formed also at both ends in the T direction of the lowermost internal electrode layer 12 due to the effect of Mg added to the side margin 16a. The same applies to the uppermost internal electrode layer 12 of the internal electrode layers 12 connected to the external electrode 20b. This can reduce or prevent a decrease in moisture resistance in the end margin 15.

The Mg concentration of the side margin 16a is, for example, 1.5 at % or greater. The Mg concentration of the side margin 16a is the Mg amount (at %) when the amount of the B-site element of the side margin 16a is defined as 100 at % in the entire side margin 16a.

To facilitate the oxidation of Ni, which is the main component metal of the internal electrode layers 12, and sufficiently oxidize and expand both ends of the outermost internal electrode layers 12 in the T direction, the Mg concentration of the side margin 16a is preferably 2.0 at % or greater. On the other hand, to reduce or prevent a decrease in dielectric constant due to excessive diffusion of Mg into the dielectric layer 11, the Mg concentration of the side margin 16a is preferably 5 at % or less, and more preferably 2.5 at % or less.

In addition, to reduce or prevent a decrease in dielectric constant, the Mg concentration of the dielectric layer 11 and the Mg concentration of the cover layer 13 are preferably 0.5 at % or less, and more preferably 0.25 at % or less. Here, the Mg concentration of the dielectric layer 11 is the amount (at %) of Mg when the amount of the B-site element of the dielectric layer 11 is defined as 100 at % in the whole of one dielectric layer 11 sandwiched between the two internal electrode layers 12 adjacent to each other. In addition, the Mg concentration in the cover layer 13 is the amount (at %) of Mg in the entire cover layer 13 when the amount of the B-site element in the cover layer 13 is defined as 100 at %.

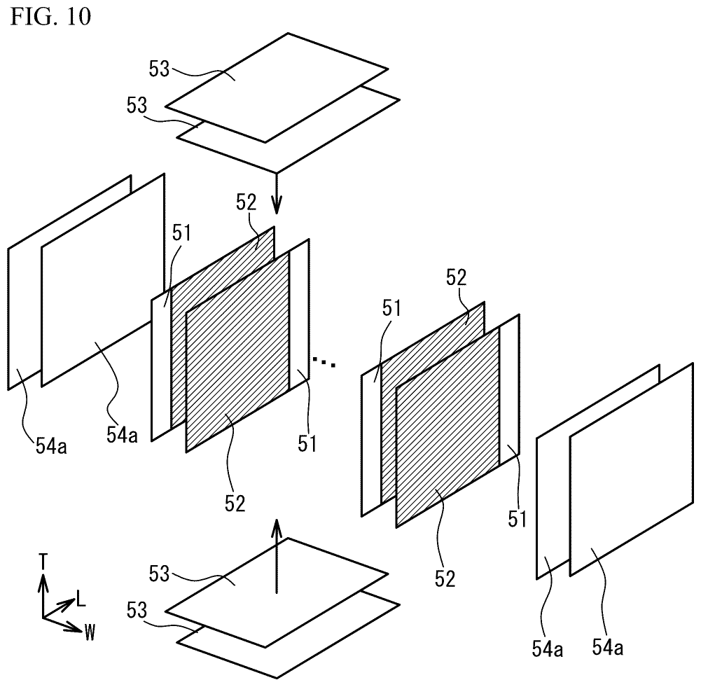

FIG. 10 illustrates an overview of a method for manufacturing the multilayer ceramic capacitor 101 according to the second embodiment. When the multilayer ceramic capacitor 101 is manufactured, for example, as illustrated in FIG. 10, the Mg concentration in a side margin sheet 54a is adjusted to be higher than the Mg concentration in the dielectric green sheet 51.

The Mg concentration of the side margin sheet 54a is, for example, 1.5 at % or greater. The Mg concentration of the side margin sheet 54a is the amount (at %) of Mg when the amount of the B-site element in the side margin sheet 54a is defined as 100 at % in the entire side margin sheet 54a.

To facilitate the oxidation of Ni, which is the main component metal of the internal electrode layers 12, and sufficiently oxidize and expand both ends in the T direction of the outermost internal electrode layers 12, the Mg concentration of the side margin sheet 54a is preferably 2.0 at % or greater. On the other hand, to reduce or prevent a decrease in dielectric constant due to excessive diffusion of Mg into the dielectric layer 11, the Mg concentration in the side margin sheet 54a is preferably 5 at % or less, and more preferably 2.5 at % or less.

In addition, to reduce or prevent a decrease in dielectric constant, the Mg concentration of the dielectric green sheet 51 and the Mg concentration of the cover sheet 53 are preferably 0.5 at % or less, and more preferably 0.25 at % or less. The Mg concentration of the dielectric green sheet 51 is the amount (at %) of Mg in the entire dielectric green sheet 51 when the amount of the B-site element of the dielectric green sheet 51 is defined as 100 at %. The Mg concentration of the cover sheet 53 is the amount (at %) of Mg in the entire cover sheet 53 when the amount of the B-site element of the cover sheet 53 is defined as 100 at %.

### Third Embodiment

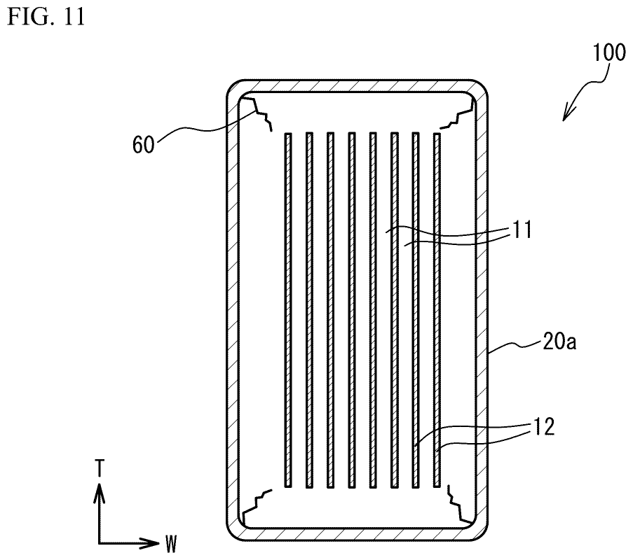

In cross sections in the W direction and the T direction (W-T cross section) at the positions of the external electrodes 20a and 20b, when the main component of the external electrodes 20a and 20b is excessively diffused from the external electrodes 20a and 20b to the internal electrode layers 12, as illustrated in FIG. 11, cracks 60 may occur in the corner portions near the external electrodes. In particular, when the main component metal of the base layer 21 is Cu and the main component metal of the internal electrode layer 12 is Ni, the diffusion is likely to occur. In addition, when a low-melting-point metal is added to the internal electrode layer 12, diffusion from the base layer 21 may be facilitated when the base layer 21 is formed.

Therefore, in a multilayer ceramic capacitor 102 according to the third embodiment, the width of the internal electrode layer 12 is varied.

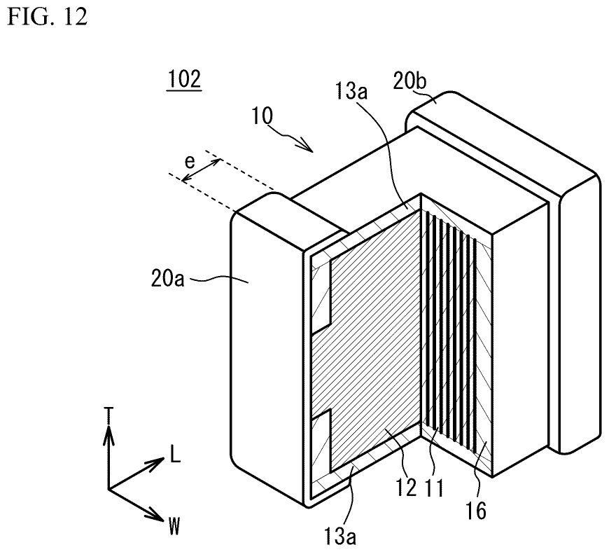

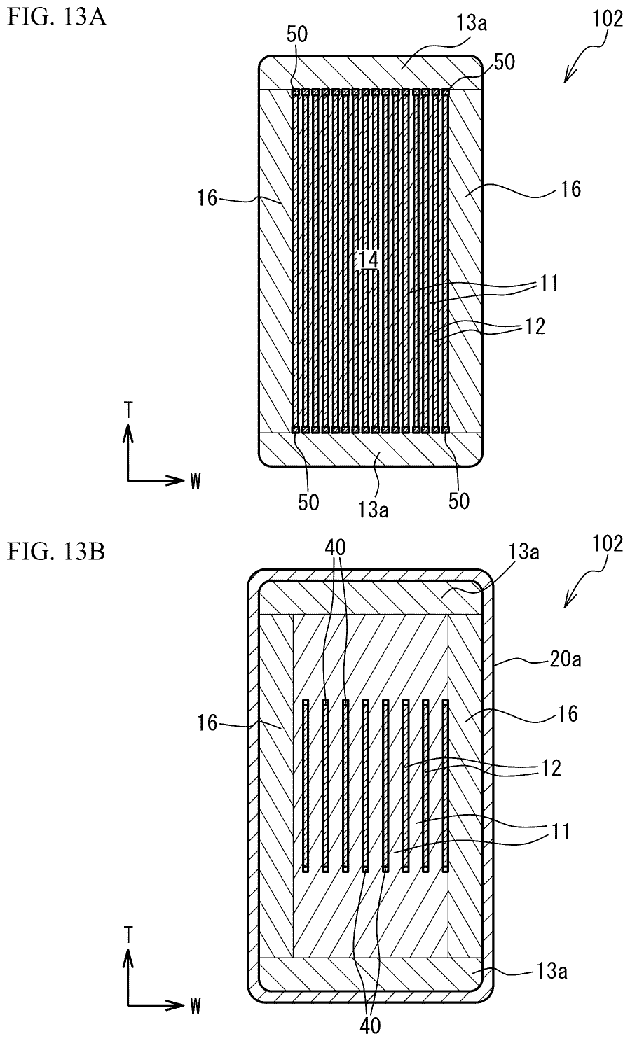

FIG. 12 is a partial cross-sectional perspective view of the multilayer ceramic capacitor 102 according to a third embodiment. FIG. 13A and FIG. 13B are cross-sectional views of the multilayer ceramic capacitor 102. FIG. 13A illustrates a cross section at the same position as in FIG. 2B, and FIG. 13B illustrates a cross section at the end margin 15.

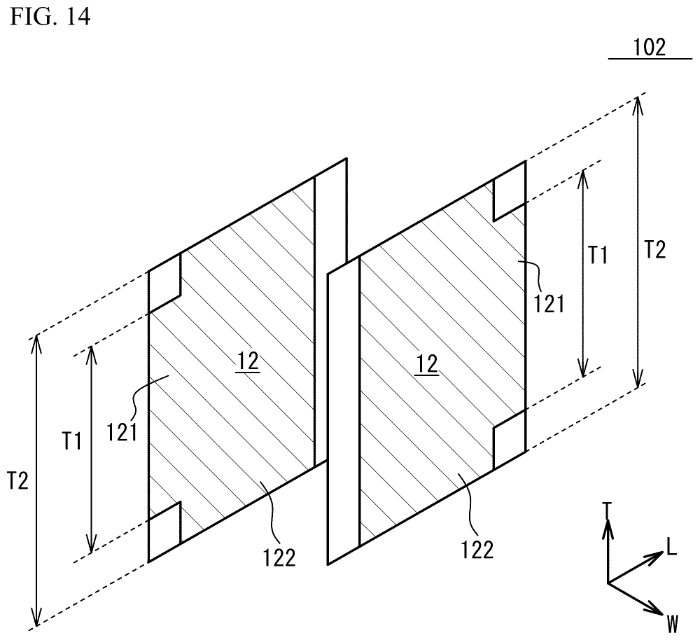

As illustrated in FIG. 14, the internal electrode layer 12 connected to the external electrode 20a includes a first section 121 (connection portion) that is connected to the external electrode 20a and has a dimension T1 in the T direction in the section corresponding to the end margin 15, and a second section 122 that has a dimension T2 in the T direction in the section corresponding to the capacitance section 14. The dimension T1 is less than the dimension T2. In the T direction, the first section 121 is located further in than the second section 122. According to this configuration, the contact area between the external electrode 20a and the internal electrode layer 12 and the contact area between the external electrode 20b and the internal electrode layer 12 are reduced, and thus the diffusion from the external electrodes 20a and 20b to the internal electrode layers 12 is suppressed. This inhibits the occurrence of the crack 60. The internal electrode layer 12 connected to the external electrode 20b also includes the first section 121 having the dimension T1 and the second section 122 having the dimension T2.

For example, if the ratio T1/T2 is small, the connectivity between the external electrodes 20a and 20b and the internal electrode layers 12 may decrease, and good conduction may not be obtained. Therefore, it is preferable to set a lower limit for the ratio T1/T2. On the other hand, if the ratio T1/T2 is large, there is a possibility that the contact area between the external electrode 20a and the internal electrode layer 12 and the contact area between the external electrode 20b and the internal electrode layer 12 cannot be sufficiently reduced. Therefore, it is preferable to set an upper limit for the ratio T1/T2. Based on the above, the ratio T1/T2 is preferably ½ or greater, and more preferably ⅔ or greater. The ratio T1/T2 is preferably ⅘ or less, and more preferably ¾ or less.

Here, as illustrated in FIG. 12, the dimensions of the external electrodes 20a and 20b extending in the L direction from respective end surfaces of the multilayer chip 10 are referred to as dimensions e. To reduce or prevent the cracks 60 in the corner portions, the dimension of the first section 121 in the L direction is preferably equal to or greater than ⅓ of the dimension e, and more preferably equal to or greater than ½ of the dimension e.

In the third embodiment, the Mg concentration of a cover layer 13a is higher than the Mg concentration of the dielectric layer 11 and the Mg concentration of the side margin 16. The Mg concentration of the side margin 16 is approximately equal to the Mg concentration of the dielectric layer 11.

As a result, as illustrated in FIG. 13A, each internal electrode layer 12 has the oxides 50 containing Ni and Mg at the ends in the T direction in the center in the L direction of the multilayer chip 10. More specifically, in the section corresponding to the capacitance section 14, each internal electrode layer 12 has the oxides 50 containing Ni and Mg at the ends in the T direction. This can reduce the voids between the ends of each internal electrode layer 12 in the T direction and the cover layers 13a, and thus can reduce or prevent the entry of moisture from between the cover layers 13a and the internal electrode layers 12 in the portion of the multilayer chip 10 not covered with the external electrodes 20a and 20b, and can improve the moisture resistance.

In the end margin 15, the voids 40 are formed between the ends in the T direction of the internal electrode layer 12 and the dielectric layer 11. In other words, the ends in the T direction of the internal electrode layer 12 are in contact with the voids 40. As a result, even when outward stresses are generated in the cover layers 13a and the side margins 16 due to the expansion of the internal electrode layers 12 caused by the diffusion of the main component metal of the external electrodes 20a and 20b, the stress can be relieved by the voids 40 and cracks can be suppressed.

The Mg concentration of the cover layer 13a is, for example, 1.5 at % or greater when the concentration of the B-site elements is defined as 100 at %. To facilitate the oxidation of Ni, which is the main component metal of the internal electrode layers 12, and sufficiently oxidize and expand both ends in the T direction of the outermost internal electrode layers 12, the Mg concentration in the cover layer 13a is preferably 2.0 at % or greater. On the other hand, to reduce or prevent a decrease in dielectric constant due to excessive diffusion of Mg into the dielectric layer 11, the Mg concentration in the cover layer 13a is preferably 5 at % or less, and more preferably 2.5 at % or less.

In addition, to reduce or prevent a decrease in dielectric constant, the Mg concentration of the dielectric layer 11 and the Mg concentration of the side margin 16 are preferably 0.5 at % or less, and more preferably 0.25 at % or less.

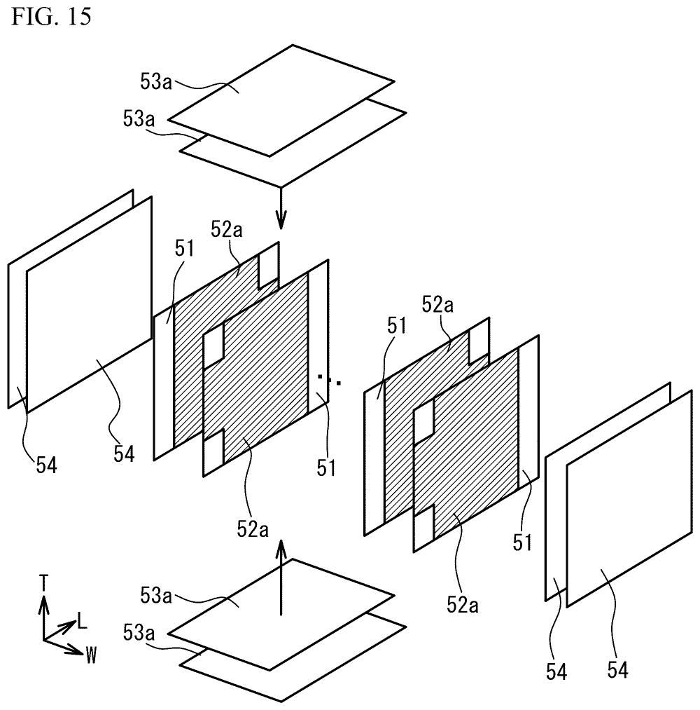

FIG. 15 illustrates an overview of a method for manufacturing the multilayer ceramic capacitor 102 according to the third embodiment. When the multilayer ceramic capacitor 102 is manufactured, as illustrated in FIG. 15, the dielectric green sheets 51 on which an internal electrode pattern 52a having the dimensions T1 and T2 is formed are stacked in the W direction. In addition, the Mg concentration of a cover sheet 53a is adjusted to be higher than the Mg concentration of the dielectric green sheet 51 and the Mg concentration of the side margin sheet 54.

The Mg concentration in the cover sheet 53a is, for example, 1.5 at % or greater. To facilitate the oxidation of Ni, which is the main component metal of the internal electrode layers 12, and sufficiently oxidize and expand both ends in the T direction of the outermost internal electrode layers 12, the Mg concentration in the cover sheet 53a is preferably 2.0 at % or greater. On the other hand, to reduce or prevent a decrease in dielectric constant due to excessive diffusion of Mg into the dielectric layer 11, the Mg concentration in the cover sheet 53a is preferably 5 at % or less, and more preferably 2.5 at % or less.

In addition, to prevent a decrease in dielectric constant, the Mg concentration of the dielectric green sheet 51 and the Mg concentration of the side margin sheet 54 are preferably 0.5 at % or less, and more preferably 0.25 at % or less.

### Fourth Embodiment

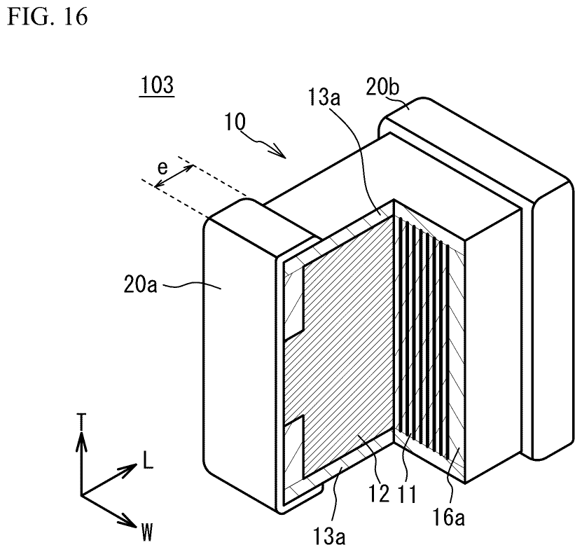

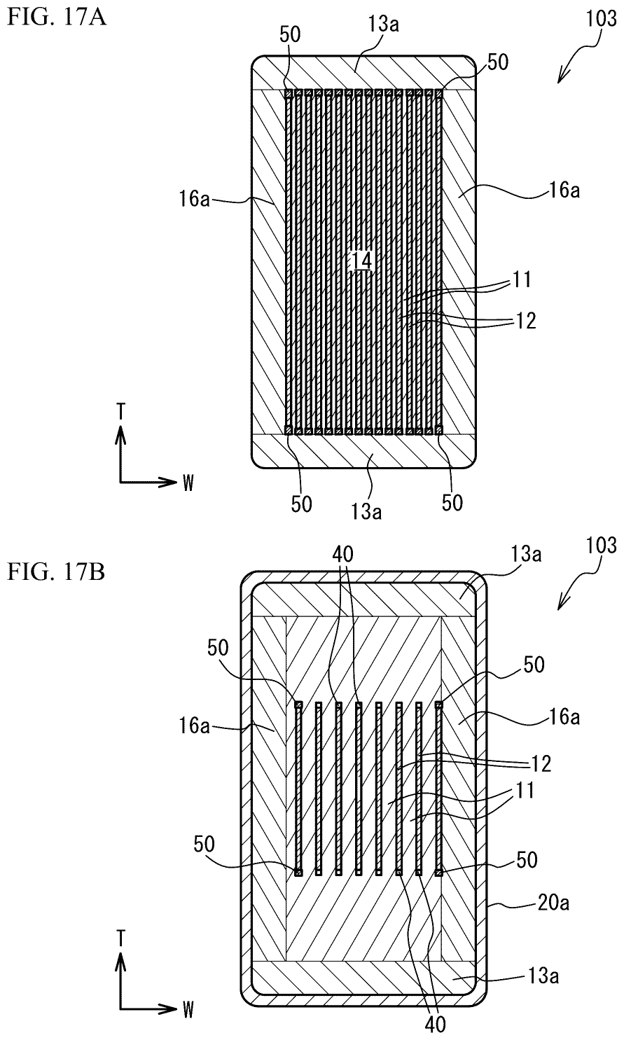

FIG. 16 is a partial cross-sectional perspective view of a multilayer ceramic capacitor 103 according to a fourth embodiment. FIG. 17A and FIG. 17B are cross-sectional views of the multilayer ceramic capacitor 103. FIG. 17A and FIG. 17B are cross-sectional views taken at the same positions as those in FIG. 13A and FIG. 13B, respectively.

The internal electrode layer 12 has the first section 121 (connection portion) having the dimension T1 in the T direction and the second section 122 having the dimension T2 in the T direction in the section corresponding to the capacitance section 14, as in the third embodiment.

In the fourth embodiment, the Mg concentration of the cover layer 13a and the Mg concentration of the side margin 16a are higher than the Mg concentration of the dielectric layer 11. Therefore, in the section corresponding to the capacitance section 14 of the multilayer chip 10, each internal electrode layer 12 has the oxides 50 containing Ni and Mg at both ends in the T direction. This can inhibit moisture from entering between the cover layer 13a and the internal electrode layer 12, and improve the moisture resistance.

In addition, in the section corresponding to the end margin 15, the outermost internal electrode layer 12 of the internal electrode layers 12 connected to the external electrode 20a have the oxides 50 containing Ni and Mg at both ends in the T direction. Among the internal electrode layers 12 connected to the external electrode 20a, the lowermost internal electrode layer 12 is not in contact with the side margin 16a having a higher Mg concentration, but the distance between the lowermost internal electrode layer 12 and the side margin 16a is short, and the internal electrode layers 12 connected to the external electrode 20b are not present, and therefore, the oxides 50 containing Ni and Mg are formed also at both ends in the T direction of the lowermost internal electrode layer 12 in the T direction due to the effect of Mg added to the side margins 16a. The same applies to the uppermost internal electrode layer 12 of the internal electrode layers 12 connected to the external electrode 20b. This can reduce or prevent a decrease in moisture resistance in the end margin 15.

In addition, in the end margin 15, since the voids 40 are formed between the ends in the T direction of the internal electrode layers 12 other than the outermost internal electrode layers 12 and the dielectric layers 11, even when outward stresses are generated in the cover layers 13a and the side margins 16a due to expansion of the internal electrode layers 12 caused by diffusion of the main component metals of the external electrodes 20a and 20b, the stresses can be relaxed by the voids 40, and the occurrence of cracks can be reduced or prevented.

The Mg concentration of the cover layer 13a and the Mg concentration of the side margin 16a are, for example, 1.5 at % or greater. To facilitate the oxidation of Ni, which is the main component metal of the internal electrode layers 12, and sufficiently oxidize and expand both ends in the T direction of the outermost internal electrode layers 12, the Mg concentration of the cover layer 13a and the Mg concentration of the side margin 16a are preferably 2.0 at % or greater. On the other hand, to reduce or prevent a decrease in dielectric constant due to excessive diffusion of Mg into the dielectric layer 11, the Mg concentration in the cover layer 13a and the Mg concentration in the side margin 16a are preferably 5 at % or less, and more preferably 2.5 at % or less.

In addition, to reduce or prevent a decrease in dielectric constant, the Mg concentration of the dielectric layer 11 is preferably 0.5 at % or less, and more preferably 0.25 at % or less.

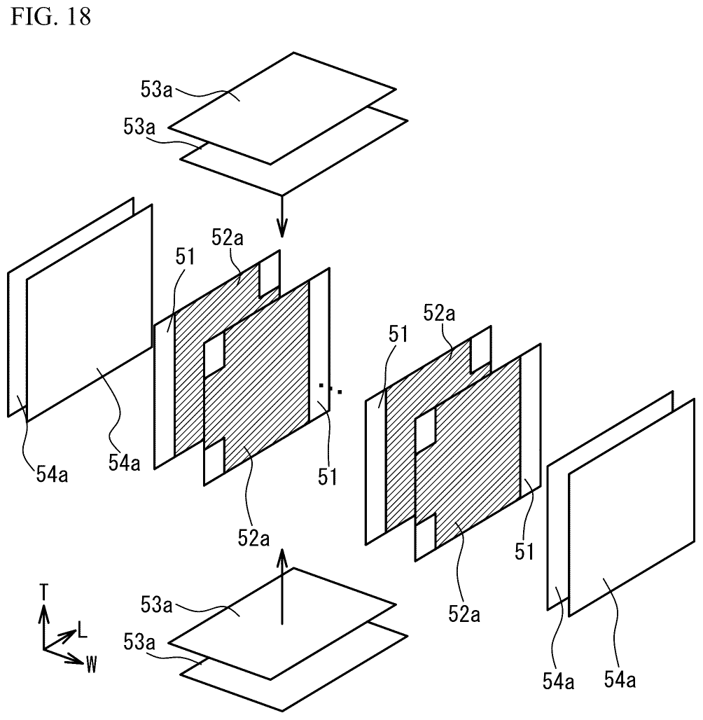

FIG. 18 illustrates an overview of a method for manufacturing the multilayer ceramic capacitor 103 according to the fourth embodiment. As illustrated in FIG. 18, in the manufacturing process of the multilayer ceramic capacitor 103, used are the side margin sheet 54a, which has a higher Mg concentration than the dielectric green sheet 51, and the cover sheet 53a, which has a higher Mg concentration than the dielectric green sheet 51. Other configurations are the same as those of the third embodiment.

The Mg concentration in the cover sheet 53a and the Mg concentration in the side margin sheet 54a are, for example, 1.5 at % or greater. To facilitate the oxidation of Ni, which is the main component metal of the internal electrode layers 12, and sufficiently oxidize and expand both ends in the T direction of the outermost internal electrode layers 12, the Mg concentration of the cover sheet 53a and the Mg concentration of the side margin sheet 54a are preferably 2.0 at % or greater. On the other hand, to reduce or prevent a decrease in dielectric constant due to excessive diffusion of Mg into the dielectric layer 11, the Mg concentration in the cover sheet 53a and the Mg concentration in the side margin sheet 54a are preferably 5 at % or less, and more preferably 2.5 at % or less.

In addition, to reduce or prevent a decrease in dielectric constant, the Mg concentration of the dielectric green sheet 51 is preferably 0.5 at % or less, and more preferably 0.25 at % or less.

### Fifth Embodiment

In the third and fourth embodiments, all the internal electrode layers 12 have the first section 121 and the second section 122, but some of the internal electrode layers 12 may have the first section 121 and the second section 122.

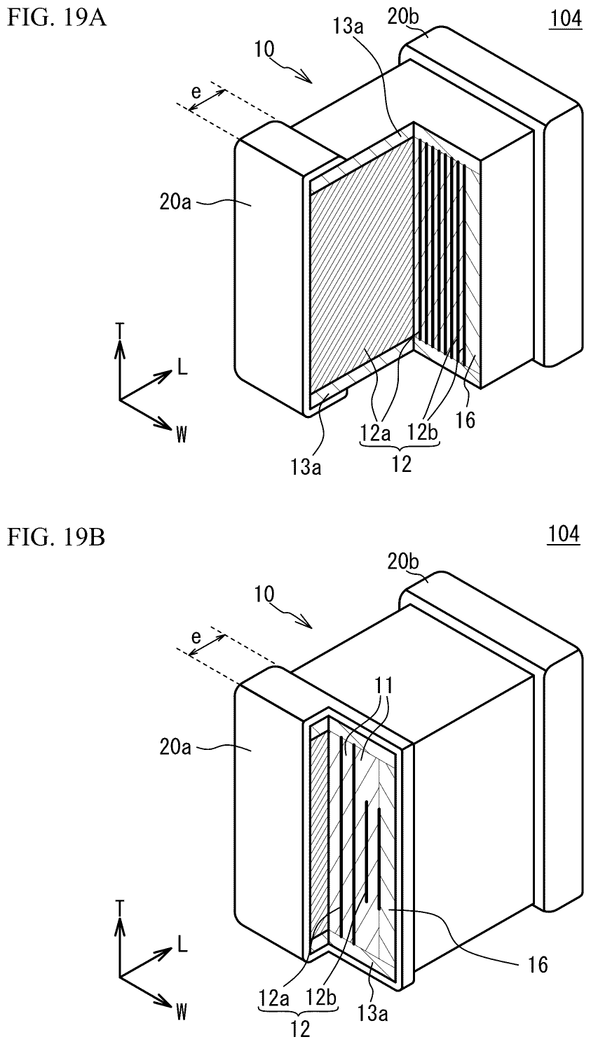

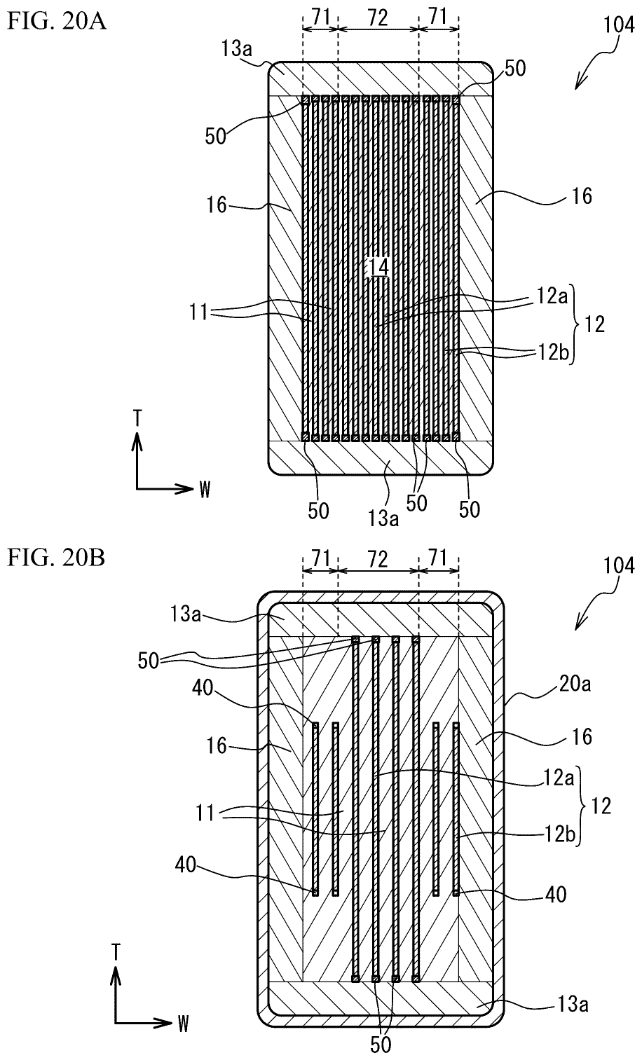

FIG. 19A and FIG. 19B are partial cross-sectional perspective views of a multilayer ceramic capacitor 104 according to a fifth embodiment. FIG. 20A and FIG. 20B are cross-sectional views of the multilayer ceramic capacitor 104. FIG. 20A and FIG. 20B are cross-sectional views taken at the same positions as those in FIG. 17A and FIG. 17B, respectively.

In the present embodiment, a plurality of the internal electrode layers 12 include outer internal electrode layers 12b, which are one or more internal electrode layers 12 from the outermost internal electrode layers 12 toward the inside, and inner internal electrode layers 12a, which are the internal electrode layers 12 provided further in than the outer internal electrode layers 12b in the W direction.

The outer internal electrode layer 12b is the internal electrode layer 12 having the first section 121 and the second section 122. On the other hand, the inner internal electrode layer 12a is the internal electrode layer 12 having a substantially constant dimension in the T direction. A section where the outer internal electrode layers 12b and the dielectric layers 11 are alternately stacked is referred to as an outer section 71, and a section in which the inner internal electrode layers 12a and the dielectric layers 11 are alternately stacked is referred to as an inner section 72. The outer sections 71 face each other with the inner section 72 interposed therebetween in the W direction.

To reduce or prevent diffusion from the external electrodes 20a and 20b to the internal electrode layers 12, a total of 10% or greater of all the internal electrode layers 12 are preferably the outer internal electrode layers 12b, and 25% or greater of all the internal electrode layers 12 are more preferably the outer internal electrode layers 12b. On the other hand, to reduce or prevent the connection defects between the external electrode 20a and the internal electrode layers 12 and between the external electrode 20b and the internal electrode layers 12, a total of 50% or less of all the internal electrode layers 12 are preferably the outer internal electrode layers 12b, and a total of 40% or less of all the internal electrode layers 12 are more preferably the outer internal electrode layers 12b.

The number of the outer internal electrode layers 12b in one of the pair of the outer sections 71 is preferably equal to the number of the outer internal electrode layers 12b in the other of the pair of the outer sections 71.

In the present embodiment, the Mg concentration of the cover layer 13a is higher than the Mg concentration of the dielectric layer 11 and the Mg concentration of the side margin 16. As a result, as illustrated in FIG. 20A, in the section corresponding to the capacitance section 14 of the multilayer chip 10, each internal electrode layer 12 has the oxides 50 containing Ni and Mg at both ends in the T direction. This can inhibit moisture from entering between the cover layer 13a and the internal electrode layer 12, and improve the moisture resistance.

In addition, in the section corresponding to the end margin 15, among the internal electrode layers 12 connected to the external electrode 20a, the inner internal electrode layers 12a have the oxides 50 containing Ni and Mg at both ends in the T direction, and both ends in the T direction of the outer internal electrode layers 12b are in contact with the voids 40. This can inhibit moisture from entering between the cover layer 13a and the internal electrode layer 12, and even when outward stresses are generated in the cover layer 13a and the side margin 16 due to expansion of the internal electrode layers 12 caused by diffusion of the main component metal of the external electrodes 20a and 20b, the stresses can be relaxed by the voids 40, and the occurrence of cracks can be reduced or prevented.

The Mg concentration in the cover layer 13a is, for example, 1.5 at % or greater. To facilitate the oxidation of Ni, which is the main component metal of the internal electrode layers 12, and sufficiently oxidize and expand both ends in the T direction of the internal electrode layers 12 in contact with the cover layer 13a, the Mg concentration of the cover layer 13a is preferably 2.0 at % or greater. On the other hand, to reduce or prevent a decrease in dielectric constant due to excessive diffusion of Mg into the dielectric layer 11, the Mg concentration in the cover layer 13a is preferably 5 at % or less, and more preferably 2.5 at % or less.

In addition, to reduce or prevent a decrease in dielectric constant, the Mg concentration of the dielectric layer 11 and the Mg concentration of the side margin 16 are preferably 0.5 at % or less, and more preferably 0.25 at % or less.

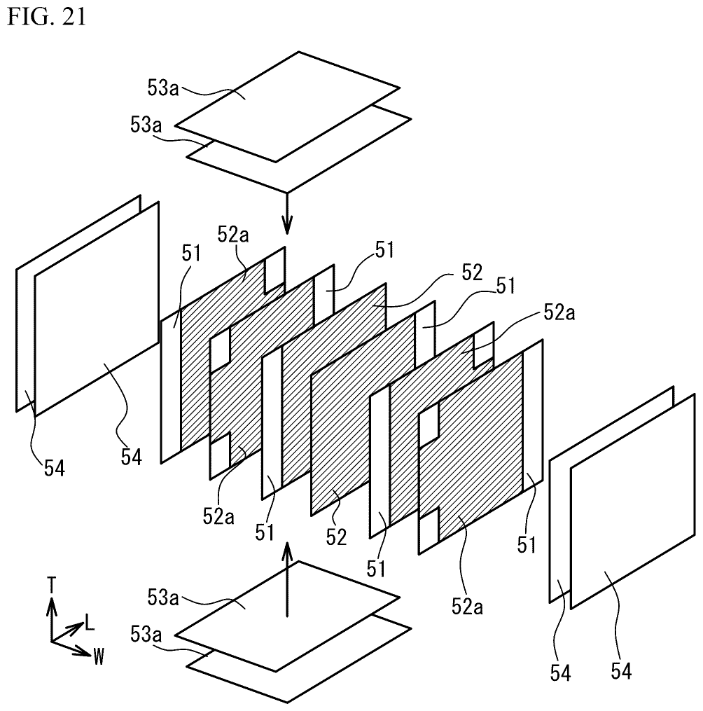

In the process of manufacturing the multilayer ceramic capacitor 104 according to the present embodiment, for example, as illustrated in FIG. 21, the dielectric green sheets 51 on which the internal electrode pattern 52a having the dimensions T1 and T2 is formed and the dielectric green sheets 51 on which the internal electrode pattern 52 having a constant dimension in the T direction is formed are stacked. In addition, the Mg concentration of the cover sheet 53a is adjusted to be higher than the Mg concentration of the dielectric green sheet 51 and the Mg concentration of the side margin sheet 54.

The Mg concentration in the cover sheet 53a is, for example, 1.5 at % or greater. To facilitate the oxidation of Ni, which is the main component metal of the internal electrode layers 12, and sufficiently oxidize and expand both ends in the T direction of the internal electrode layers 12, the Mg concentration in the cover sheet 53a is preferably 2.0 at % or greater. On the other hand, to reduce or prevent a decrease in dielectric constant due to excessive diffusion of Mg into the dielectric layer 11, the Mg concentration in the cover sheet 53a is preferably 5 at % or less, and more preferably 2.5 at % or less.

In addition, to reduce or prevent a decrease in dielectric constant, the Mg concentration of the dielectric green sheet 51 and the Mg concentration of the side margin sheet 54 are preferably 0.5 at % or less, and more preferably 0.25 at % or less.

In each of the above embodiments, a multilayer ceramic capacitor has been described as an example of a ceramic electronic component, but this does not intend to suggest any limitation. For example, the configurations of the above embodiments can be applied to other ceramic electronic components such as a varistor and a thermistor.

### EXAMPLES

Hereinafter, the multilayer ceramic capacitors according to each embodiment were fabricated, and the characteristics thereof were examined.

### Example 1-1

In Example 1-1, the multilayer ceramic capacitor described in the first embodiment was fabricated. First, a slurry containing BaTiO₃ as a main component was blended and applied to obtain a dielectric green sheet. The Mg concentration of the dielectric green sheet was adjusted to be 0 at %. The Mg concentration of the dielectric green sheet is a concentration when the Ti concentration is defined as 100 at %.

An internal electrode pattern was printed on each dielectric green sheet. For the internal electrode pattern, Ni powder was used, and Sn powder was added. The Sn concentration was adjusted to be 1.0 at %. The resulting multilayer units were stacked in 260 layers in the W direction to obtain a multilayer body.

A slurry containing BaTiO₃ as a main component was blended and applied to obtain a side margin sheet. The Mg concentration of the side margin sheet was adjusted to be 0 at %. A plurality of side margin sheets were stacked on each of the top and the bottom of the multilayer body in the stacking direction and pressure-bonded.

A slurry containing BaTiO₃ as a main component was blended and applied to obtain a cover sheet. The Mg concentration of the cover sheet was adjusted to be 0 at %. A plurality of cover sheets were attached to both ends of the multilayer body of the multilayer units in the T direction, and then a binder was removed. Thereafter, the resultant was fired and re-oxidized. A metal paste containing Cu as a main component was applied to two end surfaces of the resulting multilayer chip, and baked at around 800° C. Then, the surface was plated with Ni and Sn. Through these processes, a multilayer ceramic capacitor having a length L of 0.6 mm, a width W of 0.3 mm, and a height T of 0.4 mm, and having 260 internal electrode layers stacked in the W direction was fabricated.

In the fired multilayer ceramic capacitor, the thickness of each internal electrode layer in the W direction was 0.5 μm, and the thickness of each dielectric layer in the W direction was 0.5 μm. The thickness of each cover layer in the T direction was 20 μm. The thickness of each side margin in the W direction was 20 μm. The dimension of each internal layer in the T direction (T1=T2) was 360 μm. The dimension e of each of the external electrodes extending in the L direction from the respective end surfaces of the multilayer chip was 0.15 mm.

In the cross section of the center portion in the L direction of the fired multilayer ceramic capacitor, the dimensions in the T direction of the voids with which both ends in the T direction of the internal electrode layer were in contact, respectively, were approximately 0.5 μm.

The dimensions in the W direction of the oxides containing Ni and Mg formed at both ends in the T direction of the internal electrode layer were less than 0.1 μm.

### Example 1-2

In Example 1-2, the multilayer ceramic capacitor described in the first embodiment was fabricated. In Example 1-2, a multilayer ceramic capacitor having a length L of 0.6 mm, a width W of 0.3 mm, and a height T of 0.5 mm, and having 260 internal electrode layers stacked in the W direction was fabricated. The dimension in the T direction of each internal layer (T1=T2) was 460 μm. Other conditions were the same as those of Example 1-1.

### Example 2-1

In Example 2-1, the multilayer ceramic capacitor described in the second embodiment was fabricated. In Example 2-1, the Mg concentration of the side margin sheet was adjusted to be 1.5 at %.

In the cross section of the fabricated multilayer ceramic capacitor at the center in the L direction, the dimensions in the T direction of the voids with which both ends in the T direction of the internal electrode layer were in contact were approximately 0.5 μm. The dimensions in the W direction of the oxides containing Ni and Mg formed at both ends in the T direction of the internal electrode layer were approximately 0.5 μm. Other conditions were the same as those of Example 1-1.

### Example 2-2

In Example 2-2, the multilayer ceramic capacitor described in the second embodiment was fabricated. In Example 2-2, the Mg concentration of the side margin sheet was adjusted to be 1.5 at %.

In the cross section of the fabricated multilayer ceramic capacitor at the center in the L direction, the dimensions in the T direction of the voids with which both ends in the T direction of the internal electrode layer were in contact were approximately 0.5 μm. The dimensions in the W direction of the oxides containing Ni and Mg formed at both ends in the T direction of the internal electrode layer were approximately 0.5 μm. Other conditions were the same as those of Example 1-2.

### Example 3-1

In Example 3-1, the multilayer ceramic capacitor described in the third embodiment was fabricated. The Mg concentration of the cover sheet was adjusted to be 1.5 at %. In each of the internal electrode layers, the dimension T2 in the T direction was made larger in the capacitance section, and the dimension T1 in the T direction was made smaller in the end margin. The dimension T2 of the internal electrode layer in the capacitance section was 360 μm, and the dimension T1 of the internal electrode layer in the end margin was 300 μm. The dimension of the first section in the L direction, which is the dimension T1, was adjusted to be 0.08 mm.

In the cross section of the fabricated multilayer ceramic capacitor at the center in the L direction, the dimensions in the T direction of the voids with which both ends in the T direction of the internal electrode layer were in contact were approximately 0.5 μm. The dimensions in the W direction of the oxides containing Ni and Mg formed at both ends in the T direction of the internal electrode layer were approximately 1.0 μm. Other conditions were the same as those of Example 1-1.

### Example 3-2

In Example 3-2, the multilayer ceramic capacitor described in the third embodiment was produced. The Mg concentration of the cover sheet was adjusted to be 1.5 at %. In each of the internal electrode layers, the dimension T2 in the T direction was made larger in the capacitance portion, and the dimension T1 in the T direction was made smaller in the end margin. The dimension T2 of the internal electrode layer in the capacitance section was 460 μm, and the dimension T1 of the internal electrode layer in the end margin was 400 μm. The dimension of the first section in the L direction, which is the dimension T1, was adjusted to be 0.08 mm.

In the cross section of the fabricated multilayer ceramic capacitor at the center in the L direction, the dimensions in the T direction of the voids with which both ends in the T direction of the internal electrode layer were in contact were approximately 0.5 μm. The dimensions in the W direction of the oxides containing Ni and Mg formed at both ends in the T direction of the internal electrode layer were approximately 1.0 μm. Other conditions were the same as those of Example 1-2.

### Example 4-1

In Example 4-1, the multilayer ceramic capacitor described in the fourth embodiment was fabricated. The Mg concentration of the side margin sheet was adjusted to be 1.5 at %.

In the cross section of the fabricated multilayer ceramic capacitor at the center in the L direction, the dimensions in the T direction of the voids with which both ends in the T direction of the internal electrode layer were in contact were approximately 0.5 μm. The dimensions in the W direction of the oxides containing Ni and Mg formed at both ends in the T direction of the internal electrode layer were approximately 0.5 to 1.0 μm. Other conditions were the same as those of Example 3-1.

### Example 4-2

In Example 4-2, the multilayer ceramic capacitor described in the fourth embodiment was fabricated. The Mg concentration of the side margin sheet was adjusted to be 1.5 at %.

In the cross section of the fabricated multilayer ceramic capacitor at the center in the L direction, the dimensions in the T direction of the voids with which both ends in the T direction of the internal electrode layer were in contact were approximately 0.5 μm. The dimensions in the W direction of the oxides containing Ni and Mg formed at both ends in the T direction of the internal electrode layer were approximately 0.5 to 1.0 μm. Other conditions were the same as those of Example 3-2.

### Example 5-1

In Example 5-1, the multilayer ceramic capacitor described in the fifth embodiment was fabricated. The Mg concentration of the cover sheet was adjusted to be 1.5 at % when the Ti concentration was defined as 100 at %, and the Mg concentration of the side margin was adjusted to be 1.5 at % when the Ti concentration was defined as 100 at %.

In the outer internal electrode layers, the dimension T2 in the T direction was made larger in the capacitance section, and the dimension T1 in the T direction was made smaller in the end margin. The dimension T2 of the outer internal electrode layer in the capacitance section was 360 μm, and the dimension T1 in the end margin was 300 μm. The dimension of the first section in the L direction, which is the dimension T1, was adjusted to be 0.08 mm. The dimension of the inner internal electrode layer in the T direction (T1=T2) was 360 μm.

The number of the inner internal electrode layers stacked was 160, and the number of the outer internal electrode layers stacked in each outer section was 50.

In the cross section of the fabricated multilayer ceramic capacitor at the center in the L direction, the dimensions in the T direction of the voids with which both ends in the T direction of the internal electrode layer were in contact were approximately 0.5 μm. The dimensions in the W direction of the oxides containing Ni and Mg formed at both ends in the T direction of the internal electrode layer were approximately 0.5 μm. Other conditions were the same as those of Example 1-1.

### Example 5-2

In Example 5-2, the multilayer ceramic capacitor described in the fifth embodiment was fabricated. The Mg concentration of the cover sheet was adjusted to be 1.5 at % when the Ti concentration was defined as 5 at %, and the Mg concentration of the side margin was adjusted to be 1.5 at % when the Ti concentration was defined as 5 at %.

In the outer internal electrode layers, the dimension T2 in the T direction was made larger in the capacitance section, and the dimension T1 in the T direction was made smaller in the end margin. The dimension T2 of the outer internal electrode layer in the capacitance section was 460 μm, and the dimension T1 of the outer internal electrode layer in the end margin was 400 μm. The dimension of the first section in the L direction, which is the dimension T1, was adjusted to be 0.08 mm. The dimension of the inner internal electrode layer in the T direction (T1=T2) was 460 μm.

The number of the inner internal electrode layers stacked was 160, and the number of the outer internal electrode layers stacked in each outer section was 50.

In the cross section of the fabricated multilayer ceramic capacitor at the center in the L direction, the dimensions in the T direction of the voids with which both ends in the T direction of the internal electrode layer were in contact were approximately 0.5 μm. The dimensions in the W direction of the oxides containing Ni and Mg formed at both ends in the T direction of the internal electrode layer were approximately 0.5 μm. Other conditions were the same as those of Example 1-2.

### Comparative Example 1

In Comparative Example 1, first, a slurry containing BaTiO₃ as a main component was blended and applied to obtain a dielectric green sheet. The Mg concentration of the dielectric green sheet was adjusted to be 0 at %. An internal electrode pattern was printed on each dielectric green sheet. For the internal electrode pattern, Ni powder was used, and Sn powder was added. The concentration of Sn was adjusted to be 1.0 at % when the concentration of Ni was defined as 100 at %. The resulting multilayer units were stacked in 360 layers in the T direction to obtain a multilayer body.

A slurry containing BaTiO₃ as a main component was blended and applied to obtain a cover sheet. The Mg concentration of the cover sheet was adjusted to be 0 at %. A plurality of cover sheets were stacked on each of the top and bottom of the multilayer body in the stacking direction and pressure-bonded.

A slurry containing BaTiO₃ as a main component was blended and applied to obtain a side margin sheet. The Mg concentration of the side margin sheet was adjusted to be 0 at %. A plurality of side margin sheets were attached to both ends in the W direction of the multilayer body of the multilayer units, and then a binder was removed. Thereafter, the resultant was fired and re-oxidized. A metal paste containing Cu as a main component was applied to two end surfaces of the resulting multilayer chip, and baked at around 800° C. Then, the surface was plated with Ni and Sn. Through these processes, a multilayer ceramic capacitor having a length L of 0.6 mm, a width W of 0.3 mm, and a height T of 0.4 mm, and having 360 internal electrode layers stacked in the T direction was fabricated.

In the fired multilayer ceramic capacitor, the thickness of each internal electrode layer was 0.5 μm, and the thickness of each dielectric layer was 0.5 μm. The thickness of each cover layer in the L direction was 20 μm. The thickness of each side margin in the T direction was 20 μm. The width W1 in the W direction of each internal electrode was 260 μm. The dimension e of each of the external electrodes extending in the L direction from the respective end surfaces of the multilayer chip was 0.15 mm.

In the cross section of the resulting multilayer ceramic capacitor at the center in the L direction, the dimensions in the T direction of the voids with which both ends in the T direction of the internal electrode layer were in contact were approximately 0.5 μm. The dimensions in the W direction of the oxides containing Ni and Mg formed at both ends in the T direction of the internal electrode layer were less than 0.1 μm.

### Comparative Example 2

In Comparative Example 2, a multilayer ceramic capacitor having a length L of 0.6 mm, a width W of 0.3 mm, and a height T of 0.5 mm, and having 460 internal electrode layers stacked in the T direction was fabricated. Other conditions were the same as those of Comparative Example 1.

Table 1 presents the conditions of Examples 1-1 to 5-2 and Comparative Examples 1 and 2.

TABLE 1

| | | Internal electrode layer | |
|---|---|---|---|
| | Size | Number of | |
| | L × W × T | stacked layers | Width (μm) |
| Example 1-1 | 0.6 × 0.3 × 0.4 | 260 | T1 = T2 = 360 |
| Example 1-2 | 0.6 × 0.3 × 0.5 | 260 | T1 = T2 = 460 |
| Example 2-1 | 0.6 × 0.3 × 0.4 | 260 | T1 = T2 = 360 |
| Example 2-2 | 0.6 × 0.3 × 0.5 | 260 | T1 = T2 = 460 |
| Example 3-1 | 0.6 × 0.3 × 0.4 | 260 | T1 = 300, T2 = 360 |
| Example 3-2 | 0.6 × 0.3 × 0.5 | 260 | T1 = 400, T2 = 460 |
| Example 4-1 | 0.6 × 0.3 × 0.4 | 260 | T1 = 300, T2 = 360 |
| Example 4-2 | 0.6 × 0.3 × 0.5 | 260 | T1 = 400, T2 = 460 |
| Example 5-1 | 0.6 × 0.3 × 0.4 | Outer: 50 | Outer: |
| | | Inner: 160 | T1 = 300, T2 = 360 |
| | | Outer: 50 | Inner: T1 = T2 = 360 |
| Example 5-2 | 0.6 × 0.3 × 0.5 | Outer: 50 | Outer: |
| | | Inner: 160 | T1 = 400, T2 = 460 |
| | | Outer: 50 | Inner: T1 = T2 = 460 |
| Comparative | 0.6 × 0.3 × 0.4 | 360 | W1 = 260 |
| Example 1 | | | |
| Comparative | 0.6 × 0.3 × 0.5 | 460 | W1 = 260 |
| Example 2 | | | |

| | Mg concentration (at %) | | | Void | Oxide |
|---|---|---|---|---|---|
| | Dielectric | Cover | Side | dimension | dimension |
| | layer | layer | margin | (μm) | (μm) |
| Example 1-1 | 0 | 0 | 0 | Approx. 0.5 | Less than 0.1 |
| Example 1-2 | 0 | 0 | 0 | Approx. 0.5 | Less than 0.1 |
| Example 2-1 | 0 | 0 | 1.5 | Approx. 0.5 | Approx. 0.5 |
| Example 2-2 | 0 | 0 | 1.5 | Approx. 0.5 | Approx. 0.5 |
| Example 3-1 | 0 | 1.5 | 0 | Approx. 0.5 | Approx. 0.5 |
| Example 3-2 | 0 | 1.5 | 0 | Approx. 0.5 | Approx. 1.0 |
| Example 4-1 | 0 | 1.5 | 1.5 | Approx. 0.5 | Approx. 0.5 |
| | | | | | to 1.5 |
| Example 4-2 | 0 | 1.5 | 1.5 | Approx. 0.5 | Approx. 0.5 |
| | | | | | to 1.5 |
| Example 5-1 | 0 | 1.5 | 0 | Approx. 0.5 | Approx. 0.5 |
| Example 5-2 | 0 | 1.5 | 0 | Approx. 0.5 | Approx. 0.5 |
| Comparative | 0 | 0 | 0 | Approx. 0.5 | Less than 0.1 |
| Example 1 | | | | | |
| Comparative | 0 | 0 | 0 | Approx. 0.5 | Less than 0.1 |
| Example 2 | | | | | |

For each of Comparative Examples 1 and 2 and Examples 1-1 to 5-2, 100 samples were fabricated and subjected to a moisture resistance reliability test. Specifically, a voltage of 6.3 V was applied to each sample for 1000 hours under a temperature of 85° C. and relative humidity of 85% RH. The insulation resistance value of each sample was measured, and a sample in which the insulation resistance value after the moisture resistance reliability test was decreased by two digits or more from the insulation resistance value before the moisture resistance reliability test was determined to be rejectable, and the number of rejectable samples was counted.

In Comparative Examples 1 and 2, all samples were rejectable. In Examples 1-1 and 1-2, half of the samples were rejectable. In Example 2-1, 10 samples were rejectable, and in Example 2-2, 15 samples were rejectable. In Examples 3-1 to 5-2, there were no samples that were rejectable.

The reason why the numbers of rejectable samples in Examples 1-1 and 1-2 were smaller than those in Comparative Examples 1 and 2 is considered to be that the moisture resistance reliability was improved because the number of voids was reduced by the number (100) of the internal electrode layers in Example 1-1 as compared with Comparative Example 1, and the number of voids was reduced by the number (200) of the internal electrode layers in Example 1-2 as compared with Comparative Example 2.

The reason why the numbers of rejectable samples in Examples 2-1 and 2-2 were smaller than those in Examples 1-1 and 1-2 is considered that Ni of the internal electrode layers was oxidized by the action of Mg added to the side margins at the ends of the outermost internal electrode layers in the section not covered with the external electrodes in the section corresponding to the capacitance section, and the expansion of the internal electrode layers occurred, thereby suppressing the formation of voids. In addition, in Examples 3-1 to 5-2, it is considered that no rejectable sample was generated because oxides containing Ni and Mg were formed also at the ends of the internal electrode layers other than the outermost internal electrode layers in the sections not covered with the external electrodes in the section corresponding to the capacitance section, and the formation of voids was suppressed by the expansion of the internal electrode layers.

Next, for 100 samples of each of Examples 1-1 to 5-2, a cross section corresponding to the cross section taken along line C-C in FIG. 1B was observed. In Examples 1-1 to 5-2, no crack was observed in the corner portions in any of the samples. This is considered to be because voids were formed at the ends of a plurality of the internal electrode layers in the end margins, and expansion of the internal electrode layers due to diffusion of Cu of the external electrode was relaxed.

Next, for each of Comparative Examples 1 and 2 and Examples 1-1 to 5-2, 100 samples were mounted on a substrate so that one of two main surfaces facing each other in the T direction faced the mounting surface, and the sound volume was measured. Specifically, an alternating current voltage of 5 V was applied to each sample while increasing the frequency from 0 to 1 MHz, and the intensity (unit: dB) of the sound in the audible range generated at this time was individually measured in a soundproof and anechoic chamber (manufactured by Yokohama Sound Environmental Systems, Inc.) using a TYPe-3560-B130 manufactured by Bruel & Kjaer Japan, Inc.

In Comparative Examples 1 and 2, the sound volume exceeded 25 dB, which is considered to be the permissible value of acoustic noise in all samples, and sometimes exceeded 30 dB. On the other hand, it was confirmed that all the samples of Examples 1-1 to 5-2 had a sound volume below 25 dB. This is considered to be because, in all of Examples 1-1 to 5-2, the number of stacked layers is small as compared with the structures of Comparative Examples 1 and 2, and thus the vibration of the electrostrictive strain is small, and the layers are stacked in a direction in which the electrostrictive vibration is less likely to be transmitted to the substrate.

Although the embodiments of the present disclosure have been described in detail, it is to be understood that the various change, substitutions, and alterations could be made hereto without departing from the spirit and scope of the invention.

What is claimed is:

1. A ceramic electronic component in which a dimension in a first direction is equal to or greater than 1.3 times a dimension in a second direction orthogonal to the first direction, the ceramic electronic component comprising:
a multilayer chip having a substantially rectangular parallelepiped shape, the multilayer chip including a plurality of dielectric layers and a plurality of internal electrode layers that are alternately stacked, the internal electrode layers containing Ni as a main component, the internal electrode layers being alternately exposed to a first end surface and a second end surface, which face each other in a third direction orthogonal to the first direction and the second direction, of the multilayer chip; and
a pair of external electrodes provided on the first end surface and the second end surface, respectively, the pair of external electrodes each including a plating layer on a base layer;
wherein each of the internal electrode layers contains a metal component having a melting point of 700° C. or less, and
wherein an end in the first direction of at least one internal electrode layer of the internal electrode layers is in contact with a void.

2. The ceramic electronic component according to claim 1, wherein the metal component includes one of Ga, In, Sn, Bi, Pb, or Zn.

3. The ceramic electronic component according to claim 1, wherein a main component of the base layer is Cu.

4. The ceramic electronic component according to claim 1,
wherein the multilayer chip includes:
a pair of protective layers facing each other in the second direction with the internal electrode layers, which are stacked, interposed therebetween; and
a pair of cover layers facing each other in the first direction with the internal electrode layers and the pair of protective layers interposed therebetween,
wherein a Mg concentration of the pair of protective layers is higher than a Mg concentration of the dielectric layer and a Mg concentration of the pair of cover layers, and
wherein at least an outermost internal electrode layer of the plurality of internal electrode layers has an oxide containing Ni and Mg at an end in the first direction.

5. The ceramic electronic component according to claim 4,
wherein the Mg concentration of the pair of protective layers is 1.5 at % or greater, and
wherein the Mg concentration of the dielectric layer and the Mg concentration of the pair of cover layers are 0.5 at % or less.

6. The ceramic electronic component according to claim 1,
wherein the multilayer chip includes:
a pair of protective layers facing each other in the second direction with the internal electrode layers, which are stacked, interposed therebetween; and
a pair of cover layers facing each other in the first direction with the internal electrode layers and the pair of protective layers interposed therebetween,
wherein each of the plurality of internal electrode layers has a connection portion connected to a corresponding one of the external electrodes, the connection portion having a width smaller than a width of a remaining portion, and
wherein a Mg concentration of the pair of cover layers is higher than a Mg concentration of the dielectric layer and a Mg concentration of the pair of protective layers.

7. The ceramic electronic component according to claim 6,
wherein the Mg concentration of the pair of cover layers is 1.5 at % or greater, and
wherein the Mg concentration of the dielectric layer and the Mg concentration of the pair of protective layers are 0.5 at % or less.

8. The ceramic electronic component according to claim 6,
wherein each of the plurality of internal electrode layers has oxides containing Ni and Mg at both ends in the first direction in a center in a length direction.

9. The ceramic electronic component according to claim 1,
wherein the multilayer chip includes:
a pair of protective layers facing each other in the second direction with the internal electrode layers, which are stacked, interposed therebetween; and
a pair of cover layers facing each other in the first direction with the internal electrode layers and the pair of protective layers interposed therebetween,
wherein each of the internal electrode layers has a connection portion connected to a corresponding one of the external electrodes, the connection portion having a width smaller than a width of a remaining portion, and
wherein a Mg concentration of the pair of cover layers and a Mg concentration of the pair of protective layers are higher than a Mg concentration of the dielectric layer.

10. The ceramic electronic component according to claim 9,
wherein the Mg concentration of the pair of cover layers and the Mg concentration of the pair of protective layers are 1.5 at % or greater, and
wherein a Mg concentration of the dielectric layer is 0.5 at % or less.

11. The ceramic electronic component according to claim 9,
wherein each of the internal electrode layers has oxides containing Ni and Mg at both ends in the first direction in a center in a length direction, and
wherein at least an outermost internal electrode layer of the internal electrode layers has oxides containing Ni and Mg at both ends in the first direction.

12. The ceramic electronic component according to claim 1,
wherein the multilayer chip includes:
a pair of protective layers facing each other in the second direction with the internal electrode layers, which are stacked, interposed therebetween; and
a pair of cover layers facing each other in the first direction with the plurality of internal electrode layers and the pair of protective layers interposed therebetween,
wherein the plurality of internal electrode layers include an outer internal electrode layer that is one or more internal electrode layers from an outermost layer toward an inside, and an inner internal electrode layer located further in than the outer internal electrode layer in the second direction,
wherein a width of a connection portion, which is connected to a corresponding one of the external electrodes, of the outer internal electrode layer is less than a width of a remaining portion,
wherein a width of a connection portion, which is connected to a corresponding one of the external electrodes, of the inner internal electrode layer is substantially equal to a width of a remaining portion, and
wherein a Mg concentration of the pair of cover layers is higher than a Mg concentration of the dielectric layer.

13. The ceramic electronic component according to claim 12,
wherein the Mg concentration of the pair of cover layers is 1.5 at % or greater, and
wherein the Mg concentration of the dielectric layer is 0.5 at % or less.

14. The ceramic electronic component according to claim 12, wherein each of the outer internal electrode layer and the inner internal electrode layer has oxides containing Ni and Mg at both ends in the first direction in a center in a length direction.

15. A method of manufacturing a ceramic electronic component in which a dimension in a first direction is equal to or greater than 1.3 times a dimension in a second direction orthogonal to the first direction, the method comprising:
obtaining a first multilayer body in which a plurality of multilayer units are stacked in the second direction, each of the multilayer units including a dielectric green sheet and an internal electrode pattern formed on the dielectric green sheet, the internal electrode pattern including Ni as a main component and a metal component having a melting point of 700° C. or less added thereto;
obtaining a second multilayer body in which side margin sheets are stacked on a top and bottom of the first multilayer body in a stacking direction of the multilayer units, respectively;
obtaining a third multilayer body to which cover layers are attached, the cover layers covering a first surface and a second surface of the second multilayer body, respectively, the first surface and the second surface having the internal electrode patterns exposed therefrom; and
forming base layers containing a metal as a main component on a first end surface and a second end surface of the third multilayer body, respectively when the third multilayer body is fired or after the third multilayer body is fired, the first end surface and the second end surface facing each other.

16. A mounting board comprising:
a mounting surface; and
a pair of connection electrodes provided on the mounting surface,
wherein the pair of external electrodes of the ceramic electronic component according to claim 1 are connected to the pair of connection electrodes via solder so that one of two main surfaces facing each other in the first direction of the ceramic electronic component faces the mounting surface.
